(19) United States
(12) Patent Application Publication
(10) Pub. No.: US 2022/0351142 A1
(43) Pub. Date: Nov. 3, 2022

(54) GROUP-BASED COMMUNICATION PLATFORM INTERACTION GRAPHING

(71) Applicant: Slack Technologies, Inc., San Francisco, CA (US)

(72) Inventors: Joseph Michael McGarr, Mountain View, CA (US); Keeley Hammond, Portland, OR (US); Anuj Nair, Berkeley, CA (US); Deani Hansen, Vancouver (CA); Samuel Attard, Vancouver (CA)

(73) Assignee: Slack Technologies, Inc.

(21) Appl. No.: 17/246,444

(22) Filed: Apr. 30, 2021

(51) Int. Cl. G06Q 10/10; G06Q 10/06; H04L 12/58

(52) U.S. Cl. CPC G06Q 10/103; G06Q 10/0633; G06Q 10/063114; H04L 51/046

(57) ABSTRACT

Techniques for identifying actual communications and data flow between users of an organization exchanged via a communication platform and providing a recommended action for a user to perform based on the actual communications are described herein. The communication platform receives messages exchanged between users of the organization and generates an interaction graph representative of actual interactions (e.g., communications, data flow, etc.) between the users. The interaction graph can be based on a frequency of messages, message content (e.g., message data, attached documents, links, applications, etc.), context data (e.g., personal, business, collaborative (e.g., associated with a project, etc.), etc.), user data associated with the users (e.g., position, title, team identifiers, etc.). The communication platform compares the interaction graph to an organizational graph associated with the organization to determine a recommended action for a user to perform, such as based on an unexpected level of interaction between two or more users.

### TECHNICAL FIELD

Many organizations are arranged in a structure with various relationships (e.g., manager, associate, etc.), relative ranks, and the like associated with corresponding positions and jobs. Members of an organization may rely on the structure for identifying individuals working on particular projects (e.g., collaborative teams), understanding a workload associated with a team (e.g., unfulfilled position leading to an understaffed team, etc.), disseminating information (e.g., directors to managers, manager to associates, etc.), and the like. For example, a team of associates can be assigned to a project (e.g., development of a product). A leader of the organization can access the organizational structure to determine whether the team has a sufficient number of people to complete the project on time, such as based on a determination of existing positional vacancies associated with the team. Based on a determination that the team is sufficiently staffed to complete the project, the leader can determine to not hire or move additional associates into the team to assist with the project. However, the static nature of an organizational structure may not accurately represent a workload and/or communication flow in an organization. As such, leaders of the organization relying on the organizational structure can make decisions based on inaccurate data, thereby leading to inefficiencies and reduced productivity.

Additionally, in a traditional organizational structure, permissions associated with workspaces, communication channels, and other resources can be limited to team membership within the organizational structure. Accordingly, members of different teams may be limited in the information they can access based on the static organizational structure. However, limiting permissions based on team membership within an organizational structure may reduce overall productivity and effectiveness of an organization.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2 illustrates an example user interface for accessing organizational data associated with an organization, as described herein.

FIG. 3 illustrates an example user interface for identifying members of an organization based on one or more attributes of the members, as described herein.

FIG. 4 illustrates an example process for modifying permissions associated with a user account based on communications within an organization, as described herein.

FIG. 5 illustrates an example interaction graph of communications associated with an organization, as described herein.

FIG. 6 illustrates another example process for identifying an action to perform based on an unexpected level of interaction between members of an organization, as described herein.

FIG. 7 illustrates an example process for identifying an unexpected level of interaction between members of an organization based on assigned descriptors associated with the members, as described herein.

FIG. 8 illustrates an example process for recommending an action to perform with respect to a group of users based on a frequency of messages received by the group of users being above a threshold frequency, as described herein.

FIG. 9 illustrates an example process for recommending an action to perform to increase collaboration between groups of users, as described herein.

FIG. 10 illustrates an example process for updating an organizational graph based on communications between members of an organization, as described herein.

### DETAILED DESCRIPTION

Techniques for identifying communication and data flow between users (e.g., members) of an organization exchanged via a communication platform and providing recommended actions for users to perform based on the communication and data flow. The communication platform can be a group-based communication platform, a channel-based messaging platform, and/or any other platform for facilitating communication between and among users. In some examples, groups of the communication platform can be determined based on organizational graphs, or other organizational data, of organizations. As a non-limiting example, a user associated with a first group of an organization (e.g., a first team), which can be based on an organizational graph of the organization, can utilize communication services available via the communication platform to communicate with one or more other users of the first group, such as to collaborate on a work product. The communication platform can determine that one or more of the users of the first group often collaborate with a user associated with a second group of the organization (e.g., a second team), which can be based on the organizational graph of the organization. Based on a determination that a level of interaction between the one or more users of the first group and the user of the second group is above a threshold level of interaction, the communication platform can provide a recommended action for the user to perform with respect to the communication platform, such as to facilitate communications and optimize productivity between the one or more users of the first group and the user of the second group. That is, even though the user is associated with a second group per the organizational chart of the organization, techniques described herein can identify communication and data flow to provide insights with respect to how the user is communicating with other users of the organization, without or with little regard to the organizational chart.

In various examples, the communication platform can determine the threshold level of interaction and/or the recommended action based in part on organizational data associated with an organization. The organizational data can include data associated with the organization, such as a type of business, business locations, number of users, user data (e.g., real name, username, email address, physical location, physical address, date of hire, education, qualifications (e.g., skill, work experience, certificates, etc.), languages (e.g., preferred, additional fluency or languages understood, etc.), employment data (e.g., position, title, team association, reporting manager, etc.), etc.), team data (e.g., team members, team identifiers, associated projects, team expertise or focus areas, associated workspaces and/or channels, etc.), organization management structure, and the like. In some examples, the communication platform can be configured to receive an organizational graph that represents a hierarchical configuration of the organization, such as based on the organizational data. In some examples, the communication platform can be configured to generate the organizational graph based on the organizational data received from the organization.

In various examples, the communication platform can process messages between users of an organization and/or between users across organizations. In various examples the messages can include various types of content, such as text, emojis, reactjis (e.g., reaction emoji), GIFs, links (e.g., hyperlink to a website, hyperlink to a collaborative document), third-party application tickets (e.g., applications used as collaborative tools, etc.), and the like. In various examples, the communication platform can determine a context associated with a message based at least in part on the content associated therewith. As a non-limiting example, the communication platform can determine that a message includes a third-party application ticket associated with a collaborative engineering tool. The communication platform can determine that the users associated with the message (e.g., sending user and one or more recipient users) are collaborating or assisting one another with an engineering project. For another example, the communication platform can determine that a message includes a link to a social media application associated with a sending user, such as that used to share photographs or other personal content. The communication platform can determine that the context of the message is personal between the users.

In various examples, the communication platform can be configured to assign a weight to messages transmitted via the communication platform between users of an organization. In some examples, the weight can be determined based on the content of the message. As non-limiting examples, the weight can be determined based on a number of words, topics, keywords (e.g., work-related words, project-related words, etc.), symbols (e.g., question marks, exclamation marks, dollar signs, etc.), mentions or names included (e.g., @mention of another user, names of other users, etc.), a number of reactions to a message, types of links or applications associated with a message, files attached or associated with the message, times (e.g., timestamps) associated with messages (e.g., initial message, response time, etc.), and the like. For example, the communication platform can assign a first weight to a first message including text and a second weight to a second message including text and an application ticket. For another example, the communication platform can assign a first weight to a first message including five (5) words and a second weight to a second message including twenty (20) words. For yet another example, the communication platform can assign a first weight to a first message with fifteen (15) associated reactions and a second weight to a second message including no associated reactions.

In various examples, the communication platform can generate an interaction graph representative of communications and data flow between users of an organization. In some examples, the interaction graph can include a representation of a frequency of messages and/or associated weights of the messages (e.g., data) transmitted between the users. In at least one example, the interaction graph can include a heat map associated with communications and data flow between users, such as that based on the frequency and/or associated weights of the messages. In some examples, the interaction graph can represent the communications across an entire organization and/or between two or more organizations. In some examples, the interaction graph can represent the communications and data flow associated with a particular team, workspace, and/or channel, such as a representation of a frequency of messages and respective response times thereto.

In various examples, the communication platform can compare the interaction graph with the organizational graph to identify an unexpected level of interaction between two or more users of an organization. In some examples, the unexpected level of interaction can include a level of interaction that is above a threshold level of interaction. The threshold level of interaction can be determined based on user data, such as employment data associated with each of the two or more users, team and/or workspace membership of each of the user(s), and the like. In other words, the communication platform can determine that two or more users are communicating more frequently and/or with more substantive information (e.g., sharing work-related collaboration tools) than what would be expected based on respective team memberships, positions, titles, etc. For example, the communication platform can determine that a first user who is associated with a first team and/or workspace often shares application tickets associated with an engineering collaboration tool with a second user who is a member of a second team and/or workspace. The communication platform can determine, based on the context of the messages shared between the two users, that a level of interaction between the first user and the second is above a threshold (e.g., expected) level of interaction, the threshold being based in part on the different team and/or workspace membership.

In some examples, the threshold level of interaction can be determined based on a particular team, workspace, and/or channel. In such examples, the communication platform can determine the threshold level of interaction based on data associated with the particular team, workspace, and/or channel, such as an average frequency of interactions, average response times to messages, and the like. In some examples, the communication platform can determine an unexpected level of interaction based on a determination that a number of messages sent over time is equal to or greater than a threshold number of messages. In some examples, the communication platform can determine the unexpected level of interaction based on a determination that a response time (e.g., average response time) is equal to or greater than a threshold response time. In some examples, based on an identification of the unexpected level of interaction, the communication platform can provide an indication that a team, workspace, channel, etc. is understaffed (e.g., overloaded).

Based in part on identifying the unexpected level of interaction between the two or more users, the communication platform can identify a recommended action for a user to perform. The recommended action can include joining a workspace or team, generating a new channel to facilitate communications, utilizing collaborative applications within the communication platform, generating a board to facilitate collaboration between the users, initiating an audio or video conversation (e.g., generating an audio and/or video communication interface), hiring additional users, and the like. Continuing the example from above, the communication platform can determine a recommended action for the second user to join the first team and/or workspace or vice versa. For another example, the communication platform can determine a recommended action to hire additional people to assist with responding to messages associated with an understaffed or overloaded channel.

In some examples, the communication platform can cause the recommended action to be presented to the two or more users associated with the unexpected level of communication. In some examples, the recommended action can be provided as a pop-up notification, an automated message, or the like. In some examples, the communication platform can cause the recommended action to be presented via a channel and/or direct messaging instance between the two or more users, such as in the channel and/or direct messaging instance via which the two or more users transmit messages. In some examples, the recommended action can be presented as a personal message to at least one user of the two or more users, such as that directed to the at least one user of the two or more users. Continuing the example from above, the communication platform can generate and cause a presentation of an automated message recommending that the first user invite the second user to the first team and/or workspace, or vice versa.

In some examples, the communication platform can cause the recommended action to be presented to a different user from the two or more users associated with the unexpected level of interaction. The different user can include a manager, product manager, department head, team leader, workspace administrator, or the like that is associated with at least one of the two or more users. In some examples, the recommended action can include an inquiring about the collaboration, inviting another user to join a team and/or workspace, hiring additional people to a particular team, workspace, and/or channel, or the like. For example, the communication platform can determine that a particular channel associated with a help function (e.g., triage channel) is understaffed or overloaded (e.g., unexpected level of interaction associated therewith), such as based on a frequency of messages and/or response times thereto being equal to or greater than a threshold. The communication platform can provide a recommended action to augment the particular channel with additional members to assist in responding to help requests.

Additionally or alternatively, the communication platform can be configured to present the interaction graph to one or more users of an associated organization. As discussed above, the interaction graph includes data associated with communications and data flow between users of the organization. Accordingly, the user(s) can be informed as to a collaboration and/or productivity of each of the users of an organization. In some examples, the communication platform can provide the interaction graph via an interface configured for displaying organizational data to a requesting user. In some examples, the communication platform can receive, from a client associated with a user, a request to view an interaction graph associated with an organization or portion thereof (e.g., particular team, workspace, channel, etc.). Based on the request, the communication platform can generate and/or provide a previously generated interaction graph via the interface. Additionally, the interface can provide a means by which the user can access organizational data, such as to determine qualifications, positions, and the like associated with users of an organization.

Techniques described herein provide a means for providing recommended actions to users to facilitate communications and collaboration based on actual communications and data flow between users. Traditionally, users rely on an existing organizational structure to identify teammates (e.g., co-workers with whom to collaborate on a project). The teammates can share information via a workspace, channel, or the like associated with the particular project. At times, additional users that are not associated with the project can be pulled in to assist, such as based on an expertise of an additional user. A user requesting assistance or collaborating with the additional user may send a significant amount of data via messages to get the additional user up to speed on a project. The user and the additional user may then continue to send additional messages back and forth outside of the workspace or channel associated with the particular project. The user may then send additional messages to other users working on the project, sometimes duplicating messages sent from the additional user. In traditional systems, the messages sent to the additional user can require a significant amount of processing power and memory, such as storing the messages in a database. Utilizing the techniques described herein, the communication platform can recognize an unexpected level of interaction between the user and the additional user and can provide a recommendation to grant the additional user permissions to join the workspace, channel, or the like associated with the particular project. Accordingly, the techniques described herein can improve the functioning of a server computing device by reducing a total amount of processing power and memory required to facilitate the collaborative effort.

While the description above describes generating an interaction graph associated with a particular organization, that is not intended to be so limiting and the techniques described herein can be utilized to generate interaction graphs between different organizations. For example, a user associated with a first organization may want to know how often users associated with the first organization communicate with users of a second organization. Responsive to receiving a request for an interaction graph between the first organization and the second organization, the communication platform can generate the interaction graph based on actual communications and data flow between the two organizations, utilizing the techniques described above and below.

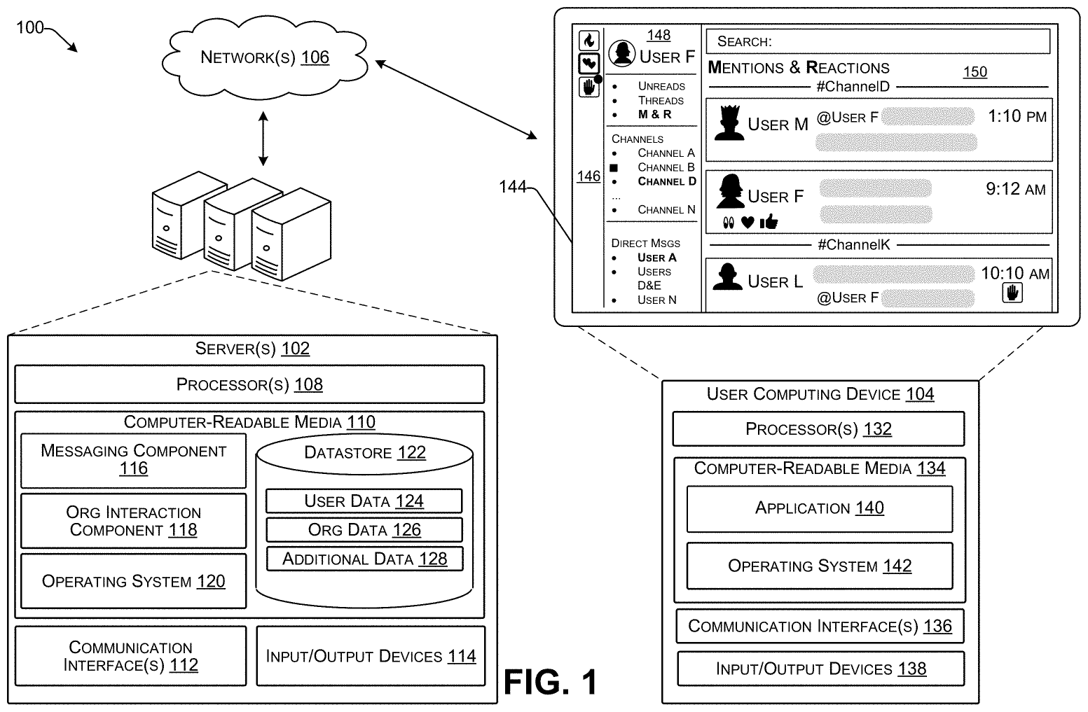

Additionally, while the description above describes generating an interaction graph based on communications transmitted via a group-based communication platform, techniques described herein can similarly be applicable to other methods of communication, such as electronic mail (email), short message service messaging, and the like. For example, an email service provider can process emails between internal and/or external users of an organization. The email service provider can then generate an interaction graph associated with the organization based on the processed emails and provide recommendations for actions to perform based on the interaction graph. As such, techniques described herein are not limited to group-based communication platforms. Additional details and examples are described below with reference to FIGS. 1-10.

FIG. 1 illustrates an example system 100 for performing techniques described herein. In at least one example, the example system 100 can be associated with a communication platform that can leverage a network-based computing system to enable users of the communication platform to exchange data. In at least one example, the communication platform can be “group-based” such that the platform, and associated systems, communication channels, messages, and/or virtual spaces, have security (that can be defined by permissions) to limit access to a defined group of users. In some examples, such groups of users can be defined by group identifiers, as described above, which can be associated with common access credentials, domains, or the like. In some examples, the communication platform can be a hub, offering a secure and private virtual space to enable users to chat, meet, call, collaborate, transfer files or other data, or otherwise communicate between or among each other. As described above, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example system 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (TOT) device, or any other computing device capable of sending communications and performing the functions according to the techniques described herein. While a single user computing device 104 is shown, in practice, the example system 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 108, computer-readable media 110, one or more communication interfaces 112, and input/output devices 114.

In at least one example, each processor of the processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include a messaging component 116, an organizational (org) interaction component 118, an operating system 120, and a datastore 122.

In at least one example, the messaging component 116 can process messages between users. That is, in at least one example, the messaging component 116 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. The communication channel, or virtual space, can be a data route used for exchanging data between and among systems and devices associated with the communication platform. In at least one example, the messaging component 116 can establish a communication channel between and among various user computing devices, allowing the user computing devices to communicate and share data between and among each other. In at least one example, the messaging component 116 can manage such communications and/or sharing of data. In some examples, data associated with a communication channel can be presented via a user interface. Additional functions of the messaging component 116 are described below.

In various examples, the messaging component 116 can receive a message from a user computing device 104 (e.g., originator of the message) and determine an intended recipient of the message. In some examples, the intended recipient can include one or more users associated with a same or a different organization from the user associated with the user computing device. For example, a first user can be associated with a first organization and can send a direct message to a second user associated with a second organization. For another example, the first user associated with the first organization can send the message via an externally shared communication channel. In such an example, at least one intended recipient of the message can be associated with a second organization.

In various examples, the messaging component 116 can store messages sent between user computing devices in the datastore 122, such as in organization data 126 and/or in additional data 128. In some examples, the messaging component 116 can store the messages based on a workspace associated therewith, user identifiers associated with the messages (e.g., sending user identifier, recipient identifier, etc.). In various examples, a workspace can be associated with a group identifier and one or more user accounts can be mapped thereto, or otherwise associated with, the group identifier. User(s) corresponding to such user account(s) can be “members” of the group.

In some examples, the messaging component 116 can store the messages based on a communication channel associated therewith. The communication channel can be associated with a workspace, or can be independent of the workspace. The communication channel, or virtual space, can be a data route used for exchanging data between and among systems and devices associated with the communication platform. In at least one example, the messaging component 116 can process messages transmitted via the communication channel between and among various user computing devices, allowing the user computing devices to communicate and share data between and among each other. In at least one example, the messaging component 116 can cause the messages to be presented based on a channel and/or workspace associated therewith. In various examples, the messaging component 116 can store the messages in the datastore 122 based in part on the channel and/or workspace associated therewith.

In at least one example, the datastore 122 can be configured to store data that is accessible, downloadable, manageable, and updatable. In some examples, the datastore 122 can be integrated with the server(s) 102, as shown in FIG. 1. In other examples, the datastore 122 can be located remotely from the server(s) 102 and can be accessible to the server(s) 102 and/or user device(s), such as the user device 104. Additional or alternative data can be stored in the datastore 122 and/or in one or more other data stores.

In at least one example, the org interaction component 118 can determine a context associated with each message transmitted between the users of the organization. The context can include a purpose or intent of a particular message, such as whether the message is personal (e.g., personal information shared, etc.) or a professional (e.g., associated with a particular project, associated with a collaborative effort, etc.). In some examples, the org interaction component 118 can determine the context based at least in part on content included in the message. The content included in the message can include text, emojis, reactjis, files (e.g., documents, photographs, etc.), links (e.g., hyperlink to a website, hyperlink to a collaborative document), third-party application tickets (e.g., applications used as collaborative tools, etc.), and the like. For example, the org interaction component 118 can determine that a message includes a third-party application ticket associated with a collaborative engineering tool. The org interaction component 118 can determine that the context of the message is professional and is associated with a particular engineering project. For another example, the org interaction component 118 can determine that a message includes an attached file with an associated label indicating that the file is a Christmas card. The org interaction component 118 can determine that the message includes a personal message shared between users.

In various examples, the org interaction component 118 can analyze the content of the message to determine the context. In some examples, the org interaction component 118 can be configured to utilize text recognition techniques, such as optical character recognition, to determine the context of text included in a message. In various examples, the org interaction component 118 can analyze the text included in the message, in attached files and/or labels associated with the files, links, and the like, to determine the context. For example, the org interaction component 118 can determine that a message sent from a first user to a second user includes an attachment labeled “my new puppy!!” Based on the label associated with the attachment, the org interaction component 118 can determine that the context of the message is personal. For another example, the org interaction component 118 can determine that a message transmitted between users includes a link to a document stored in a cloud-based storage system that enables two or more users to share, comment, modify, or otherwise collaborate on the document. Based on a determination that the link is associated with a collaborative tool, the org interaction component 118 can determine that the context of the message is professional.

In some examples, the org interaction component 118 can be configured to determine the context based on keywords included in the message and/or a topic associated with the message. In such examples, the org interaction component 118 can be configured to identify the keywords in the message and/or determine a topic based at least in part on context data. The keywords can include words associated with particular projects, teams, workspaces, channels, words identified as pertinent to management, administration of the communication platform, or other functions of the organization. The topic can include a subject associated with a message. In some examples, a user with administrative privileges with respect to the communication platform (e.g., administrator of an organization that subscribes to the communication platform) can store one or more keywords and/or topics associated with the organization, such as in org data 126. In such examples, the org interaction component 118 can identify the keywords based in part on the org data 126. In some examples, the org interaction component 118 can determine the keywords based on a frequency of use in messages transmitted between users of an organization that subscribes to the communication platform. In such examples, the org interaction component 118 can determine that a frequency of use of a particular word is equal to or greater than a threshold frequency. Based on a determination of the frequency of use is greater than the threshold frequency, the org interaction component 118 can classify the particular word as a keyword. In some examples, the org interaction component 118 can be configured to determine the subject based in part on identified keyword(s) in a message and/or other words, emojis, or the like associated with the message.

In some examples, the org interaction component 118 can be configured to determine a context of the message based at least in part on characteristics of the associated users (e.g., sending user or sender and receiving user(s) or recipient(s)). The characteristics of the users can be determined based on user data 124, such as a real name, username, email address, physical location, physical address, date of hire, education, qualifications (e.g., skill, work experience, certificates, etc.), languages (e.g., preferred, additional fluency or languages understood, etc.), employment data (e.g., position, title, team association, reporting manager, etc.), etc.). In at least one example, the org interaction component 118 can determine the context in part based on employment data corresponding to the associated users, such as a first position associated with a sender and a second position associated with a recipient of the message. For example, the org interaction component 118 can determine that a message sent from a manager to a subordinate includes a professional context.

In some examples, the org interaction component 118 can assign weights to the messages. In some examples, the weights can be determined based on the context and/or content of the messages. As non-limiting examples, the weight can be determined based on a number of words, an identified topic, keywords (e.g., work-related words, project-related words, etc.), symbols (e.g., question marks, exclamation marks, dollar signs, etc.), mentions or names included (e.g., @mention of another user, names of other users, etc.), a number of reactions to a message, types of links or applications associated with a message, files attached or associated with the message, times (e.g., timestamps) associated with messages (e.g., initial message, response time, etc.), and the like. For example, the org interaction component 118 can assign a first weight to a first message including text and a second weight to a second message including text and an application ticket. For another example, the communication platform can assign a first weight to a first message including two (2) keywords and a second weight to a second message including no keywords. For yet another example, the communication platform can assign a first weight to a first message with twenty (20) associated reactions and a second weight to a second message including no associated reactions.

In at least one examples, the org interaction component 118 can determine a weight of a message based on a quality of the information included therein. The quality can be based on a richness of content and/or context of the message, such as a determined level of importance of the information shared in the message. In some examples, the org interaction component 118 can determine the quality of the information based on text recognition of the content therein. In some examples, the org interaction component 118 can determine the quality based on an associated label, identified topic, or keyword, such as a message that is labeled as urgent or includes the word urgent in a text string. In some examples, the org interaction component 118 can determine the quality of the message based on a ratio of keywords to non-keywords in the text string of the message.

In various examples, the org interaction component 118 can determine the weights based on characteristics associated with the sender and/or recipient(s) of the message. In such examples, the weights can be determined based on the user data 124. For example, a message sent from a Chief Executive Officer of an organization can be weighted greater than messages sent from other users of the organization. For another example, the org interaction component 118 can assign a first weight to a first message including professional context between a manager of a first team and a subordinate associated with the first team and a second weight to a second message including professional context between the manager of the first team and a member of a second team that is different from the first team. For yet another example, the org interaction component 118 can assign a first weight to a first message including a professional context between members of a first team and a second weight to a second message including a professional context between a member of the first team and a member of a second team.

In at least one example, the org interaction component 118 can generate an interaction graph based on the messages and weights associated therewith. The interaction graph can represent communications and data flow between users of an organization. In various examples, the interaction graph can represent real-time collaborations and/or working relationships between users of the organization. In such examples, the interaction graph can represent how work is actually being completed within an organization. In various examples, the org interaction component 118 can generate the interaction graph based on first-party information (e.g., messages exchanged between users) and/or third-party data received from one or more third-party resources (e.g., third-party service providers, etc.).

In some examples, the interaction graph can include a representation of a frequency of messages and/or associated weights of the messages (e.g., data) transmitted between the users. In at least one example, the interaction graph can include a heat map associated with communications and data flow between users, such as that based on the frequency and/or associated weights of the messages. In some examples, the interaction graph can represent the communications across an entire organization and/or between two or more organizations. In some examples, the interaction graph can represent the communications and data flow associated with a particular team, workspace, and/or communication channel, such as a representation of a frequency of messages and respective response times thereto.

In some examples, the interaction graph can include a representation of a frequency of messages and/or associated weights of messages sent by a particular user. In such examples, the interaction graph can represent a level of effectiveness and/or a professional contribution that the particular user adds to a team and/or an organization. In some examples, the org interaction component 118 can identify one or more users with a contribution level to a team and/or an organization that is above a threshold level. In some examples, the org interaction component 118 can include an indication that the overall contribution level of the user(s) is above a threshold level in the interaction graph and/or in a separate message to a manager or leader of the organization. For example, the org interaction component 118 can determine that a particular user frequently sends messages to other users with suggestions for collaborative tools to use, responds to inquiries from other users within an average threshold time, and receives many positive reactions to the response messages. The org interaction component 118 can identify, based on the frequency and/or weights of the messages sent by the particular user, the particular user as having a contribution level above a threshold level for the organization. The org interaction component 118 can include an indication of the contribution level on the interaction graph, such as by changing a color or symbol associated with an indicator of the particular user depicted in the interaction graph, or the like.

In various examples, the org interaction component 118 can be configured to compare the interaction graph with an organizational graph of an organization to identify an unexpected level of interaction between two or more users of the organization. The organizational graph can include a representation of a structure of working relationships within an organization. For example, the organizational graph may include a head of an organization (e.g., president, CEO, etc.), managers associated with different teams, and team members who report to respective managers. In some examples, the org interaction component 118 may be configured to determine the organizational graph based on org data 126, such as a type of business, business locations, number of users, user data associated with users of the organization, team data (e.g., team members, team identifiers, associated projects, team expertise or focus areas, associated workspaces and/or channels, etc.), organization management structure, and the like. In such examples, the org interaction component 118 can be configured to generate the organizational graph based on the organizational data. In some examples, the organizational data can include the organizational graph, such as in pre-determined structure of working relationships within the organization. In such examples, the org interaction component 118 can receive the organizational graph, such as from an administrator or manager of the organization and can store the organizational graph as org data 126 associated with the organization.

In various examples, the org interaction component 118 can be configured to identify the unexpected level of interaction between user(s) of the organization based on a determination that a level of interaction between user(s) is above a threshold level of interaction. The threshold level of interaction can be determined based on user data, such as employment data associated with each of the two or more users, team and/or workspace membership of each of the user(s), and the like. In other words, the org interaction component 118 can determine that two or more users are communicating more frequently and/or with more substantive information (e.g., sharing work-related collaboration tools) than what would be expected based on respective team memberships, positions, titles, etc. For example, the org interaction component 118 can determine that a first user who is associated with a first team and/or workspace often shares application tickets associated with an engineering collaboration tool with a second user who is a member of a second team and/or workspace. The communication platform can determine, based on the context of the messages shared between the two users, that a level of interaction between the first user and the second is above a threshold (e.g., expected) level of interaction, the threshold being based in part on the different team and/or workspace membership.

In some examples, the org interaction component 118 can determine the threshold level of interaction based on a particular team, workspace, and/or channel. In such examples, the org interaction component 118 can determine the threshold level of interaction based on data associated with the particular user, team, workspace, and/or channel, such as an average frequency of interactions, average response times to messages, and the like. In some examples, the org interaction component 118 can determine an unexpected level of interaction based on a determination that a frequency of messages received by the particular user, team, workspace, and/or channel is equal to or greater than a threshold frequency associated with the particular team, workspace, and/or channel. In some examples, the org interaction component 118 can determine the unexpected level of interaction based on a determination that a response time (e.g., average response time) to the messages associated with the particular user, team, workspace, and/or channel is equal to or greater than a threshold response time. In some examples, based on an identification of the unexpected level of interaction, the org interaction component 118 can provide an indication that a particular user is overworked and/or that the team, workspace, channel, etc. is understaffed (e.g., overloaded).

In response to identifying an unexpected level of interaction between the user(s) of the organization, the org interaction component 118 can identify a recommended action for a user to perform with respect to the organization and/or the communication platform. The recommended action can include modifying permissions with respect to a workspace, channel, or the like, joining a workspace or team, generating a new channel to facilitate communications and/or collaboration (e.g., connecting user(s) based on keywords and/or identified topics, collaborative tools frequently used, etc.), utilizing collaborative applications within the communication platform, generating a board to facilitate collaboration between the users, initiating an audio and/or video conversation, hiring additional users (e.g., hire new employees, move employees between teams, augment a team for a period of time, etc.), and the like. For example, the org interaction component 118 can determine that a frequency of messages received via a particular channel associated with a help function (e.g., triage channel) is above a threshold frequency and/or that response times to the messages are greater than a threshold response time. Based on the frequency of messages and/or the response times being greater than the respective thresholds, the org interaction component 118 can determine that the channel is understaffed (e.g., unexpected level of interaction associated therewith). The org interaction component 118 can thus provide a recommended action to modify permissions with respect to the particular channel to add additional members (e.g., modify permissions associated with a user account to enable the user access to receive and send messages via the channel) to assist in responding to help requests. For another example, the org interaction component 118 can determine that users associated with two separate teams are utilizing a same new collaborative tool in a similar manner. The org interaction component 118 can provide a recommended action to one or more of the users to generate a board or channel to communicate lessons learned associated with the new collaborative tool, such as to improve productivity of both of the teams.

In various examples, the org interaction component 118 can cause the recommended action to be presented to at least one user of the users associated with the unexpected level of communication. In some examples, the recommended action can be provided as a pop-up notification, an automated message, or the like. In some examples, the communication platform can cause the recommended action to be presented via a channel and/or direct messaging instance between the users associated with the unexpected level of interaction, such as in the channel and/or direct messaging instance via which the users transmit messages. In some examples, the recommended action can be presented as a personal message to the at least one user of the two or more users, such as that directed to the at least one user. For example, the org interaction component 118 can determine an unexpected level of interaction between two users of different teams, based on a determination that the two users frequently share links associated with third party application tickets and/or other collaborative tools. The org interaction component 118 can generate a recommended action for a first user to invite a second user to join a first team and/or workspace based on the unexpected level of interaction. The org interaction component 118 can cause an automated message including the recommended action to be presented via an interface of a client associated with the first user (e.g., on the user computing device 104).

In some examples, org interaction component 118 can cause the recommended action to be presented to a user that is different from the users associated with the unexpected level of interaction. The different user can include a manager, product manager, department head, team leader, workspace administrator, or the like that is associated with at least one of the users associated with the unexpected level of interaction. In some examples, the recommended action can include inquiring about the collaboration, inviting another user to join a team and/or workspace, hiring additional people to a particular team, workspace, and/or channel, or the like. Continuing the example from above with regard to the two users associated with different teams, the org interaction component 118 can identify a manager associated with the first user and can send an indication of the unexpected level of interaction between the first user and the second user and/or a recommended action for the manager to perform based on the unexpected level of interaction, such as to modify permissions associated with a workspace of the team, such as to grant the second user access to the workspace, request that the second user be associated with the first team (e.g., move from a second team to the first team), generating a board, or initiating an audio and/or video conversation for additional users to learn from the collaborative efforts between the first user and the second user, or the like.

In at least one example, the operating system 120 can manage the processor(s) 108, computer-readable media 110, hardware, software, etc. of the server(s) 102.

In at least one example, the datastore 122 can be configured to store data that is accessible, manageable, and updatable. In some examples, the datastore 122 can be integrated with the server(s) 102, as shown in FIG. 1. In other examples, the datastore 122 can be located remotely from the server(s) 102 and can be accessible to the server(s) 102 and/or user device(s), such as the user device 104. The datastore 122 can comprise multiple databases, which can include user data 124, org data 126, additional data 128, such as data associated with workspaces, channels, (e.g., permissions data, member data, etc.), and the like. Additional or alternative data may be stored in the data store and/or one or more other data stores.

In at least one example, the user data 124 can store data associated with users of the communication platform. The user data 124 can include a real name, username, email address, physical location, physical address, date of hire, education, qualifications, languages, employment data, and the like associated with the user. In at least one example, the user data 124 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the org (organizational) data 126 can include data associated with the organization, such as an organizational graph, a type of business, business locations, number of users, team data (e.g., team members, team identifiers, associated projects, team expertise or focus areas, associated workspaces and/or channels, keywords (e.g., terminology, code, group of one or more words with a known meaning, etc.), organization management structure, and the like. Additionally, in some examples, the org data 126 can include at least a portion of the user data 124 for users associated with a particular organization.

In some examples, the org data 126 can additionally include permission data associated with users, workspaces, teams, channels, or the like that are associated with the organization. In some examples, one or more permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. In some examples, permissions associated with an individual user can be mapped to, or otherwise associated with, an account or profile associated with the user data 124. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In some examples, the org data 126 can include workspace data associated with individual workspaces. In some examples, the workspace data can include an associated group identifier that indicates a physical address in the datastore 122 where data related to the corresponding workspace is stored. In at least one example, data associated with workspace permissions can be stored in association with the group identifier, data identifying users associated with the workspace can be stored in association with the group identifier, data associated with messages and/or other content associated with the workspace can be stored in association with the group identifier, data associated with communication channels associated with the workspace can be stored in association with the group identifier, and the like. In some examples, workspaces can be associated with one or more organization identifiers, which can be associated with organizations or other entities associated with the communication platform. In some examples, such data can be mapped to, or otherwise associated with, other types of data in the datastore 122 (e.g., the user data 124, the additional data 128, etc.).

In some examples, the org data 126 can include channel data corresponding to individual communication channels associated with an organization. As discussed above, the server(s) 102 can be configured to establish one or more communication channels between and among various user computing devices, allowing the user computing devices to communicate and share data between and among each other. In at least one example, a communication channel identification may be assigned to a communication channel, which indicates the physical address in the datastore 122 where data related to that communication channel is stored. A communication channel may be “public,” which may allow any user within an organization (e.g., associated with an organization identifier) to join and participate in the data sharing through the communication channel, or a communication channel may be “private,” which may restrict data communications in the communication channel to certain users or users having particular roles (e.g., managers, administrators, etc.). In some examples, a communication channel may be “shared,” which may allow users associated with different organizations (e.g., entities associated with different organization identifiers) to join and participate in the data sharing through the communication channel. Shared channels may be public such that they are accessible to any user of either organization, or they may be private such that they are restricted to access by certain users or users having particular roles from both organizations.

Additionally, the user data 124, org data 126, and/or additional data 128 can include one or more other means of facilitating communication between users that are associated with at least one organization. As non-limiting examples, the other mean(s) of facilitating communications can include boards, audio and/or video communication interfaces, direct messaging instances, and the like.

In some examples, the datastore 122 can be partitioned into discrete items of data that may be accessed and managed individually (e.g., data shards). Data shards can simplify many technical actions, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 122 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared channel).

In some examples, individual groups can be associated with a database shard within the datastore 122 that stores data related to a particular group identification (e.g., workspace, team, etc.). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a communication channel can be associated with a database shard within the datastore 122 that stores data related to a particular channel identification. For example, a database shard may store electronic communication data associated with the communication channel, which enables members of that particular communication channel to communicate and exchange data with other members of the same communication channel in real time or near-real time. In this example, a group or organization can be the owner of the database shard and can control where and how the related data is stored.

In some examples, individual users can be associated with a database shard within the datastore 122 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via Web sockets, Application Programming Interfaces (APIs) (e.g., using API calls), HyperText Transfer Protocols (HTTPs), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 132, computer-readable media 134, one or more communication interfaces 136, and input/output devices 138.

In at least one example, each processor of the processor(s) 132 can be a single processing unit or multiple processing units, and can include single or multiple computing units or multiple processing cores. The processor(s) 132 can comprise any of the types of processors described above with reference to the processor(s) 108 and may be the same as or different than the processor(s) 108.

The computer-readable media 134 can comprise any of the types of computer-readable media 134 described above with reference to the computer-readable media 110 and may be the same as or different than the computer-readable media 110. Functional components stored in the computer-readable media can optionally include at least one application 140 and an operating system 142.

In at least one example, the application 140 can be a mobile application, a web application, or a desktop application, which can be provided by the communication platform or which can be an otherwise dedicated application. In some examples, individual user computing devices associated with the system 100 can have an instance or versioned instance of the application 140, which can be downloaded from an application store, accessible via the Internet, or otherwise executable by the processor(s) 132 to perform operations as described herein. That is, the application 140 can be an access point, enabling the user computing device 104 to interact with the server(s) 102 to access and/or use communication services available via the communication platform. In at least one example, the application 140 can facilitate the exchange of data between and among various other user computing devices, for example via the server(s) 102. In at least one example, the application 140 can present user interfaces, as described herein. In at least one example, a user can interact with the user interfaces via touch input, keyboard input, mouse input, spoken input, or any other type of input.

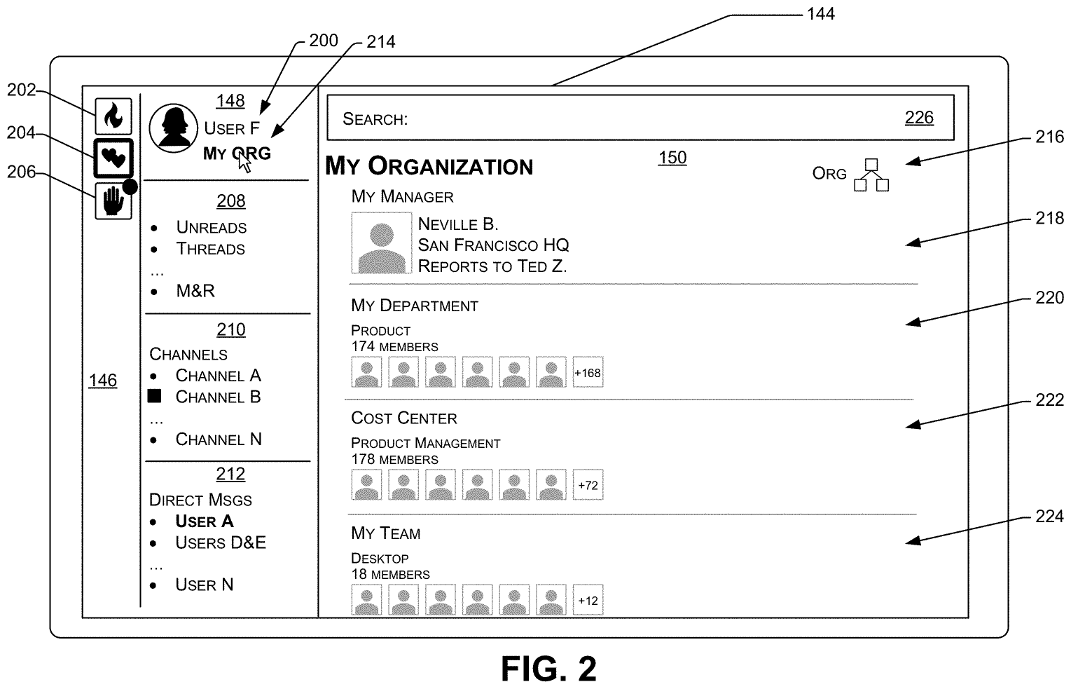

A non-limiting example of a user interface 144 is shown in FIG. 1. As illustrated in FIG. 1, the user interface 144 can present data associated with one or more communication channels and, in some examples, one or more workspaces. That is, in some examples, the user interface can integrate data from multiple workspaces into a single user interface so that the user (e.g., of the user computing device 104) can access and/or interact with data associated with the multiple workspaces that he or she is associated with and/or otherwise communicate with other users associated with the multiple workspaces. In some examples, the user interface 144 can include a first region 146, or pane, that includes indicator(s) (e.g., user interface element(s) or object(s)) associated with workspace(s) with which the user (e.g., account of the user) is associated. In some examples, the user interface 144 can include a second region 148, or pane, that includes indicator(s) (e.g., user interface element(s) or object(s)) representing data associated with the workspace(s) with which the user (e.g., account of the user) is associated. Additional details associated with the second region 148 and indicator(s) are described below with reference to FIG. 2.

In at least one example, the user interface 144 can include a third region 150, or pane, that can be associated with a data feed (or, “feed”) indicating messages posted to and/or actions taken with respect to one or more communication channels and/or other virtual spaces for facilitating communications (e.g., a virtual space associated with direct message communication(s), a virtual space associated with event(s) and/or action(s), etc.) as described herein. In at least one example, data associated with the third region 150 can be associated with the same or different workspaces. That is, in some examples, the third region 150 can present data associated with the same or different workspaces via an integrated feed. In some examples, the data can be organized and/or is sortable by workspace, time (e.g., when associated data is posted or an associated operation is otherwise performed), type of action, communication channel, user, or the like. In some examples, such data can be associated with an indication of which user (e.g., member of the communication channel) posted the message and/or performed an action. In examples where the third region 150 presents data associated with multiple workspaces, at least some data can be associated with an indication of which workspace the data is associated with. Additional details associated with the user interface 144, and the third region 150, are described below with reference to FIG. 2.

In at least one example, the operating system 142 can manage the processor(s) 132, computer-readable media 134, hardware, software, etc. of the server(s) 102.

The communication interface(s) 136 can include one or more interfaces and hardware components for enabling communication with various other devices (e.g., the user computing device 104), such as over the network(s) 106 or directly. In some examples, the communication interface(s) 136 can facilitate communication via Websockets, APIs (e.g., using API calls), HTTPs, etc.

The user computing device 104 can further be equipped with various input/output devices 138 (e.g., I/O devices). Such I/O devices 138 can include a display, various user interface controls (e.g., buttons, joystick, keyboard, mouse, touch screen, etc.), audio speakers, connection ports and so forth.

While techniques described herein are described as being performed by the messaging component 116, the org interaction component 118, and the application 140, techniques described herein can be performed by any other component, or combination of components, which can be associated with the server(s) 102, the user computing device 104, or a combination thereof.

FIG. 2 illustrates additional details associated with the user interface 144 that presents data associated with an organization of a corresponding user 200.

As described above, in at least one example, the user interface 144 can include a first region 146, or pane, that includes indicator(s) (e.g., user interface element(s) or object(s)) of workspace(s) with which the user (e.g., account of the user) is associated. As illustrated in FIG. 2, the user (e.g., User F) can be associated with three different workspaces. In some examples, the workspaces can be associated with a same organization (e.g., associated with a same organization identifier). In some examples, one or more of the workspaces can be associated with different organizations (e.g., associated with different organization identifiers). In some examples, one of the workspaces can be associated with users from a single organization (e.g., associated with a same organization identifier) and another of the workspaces can be associated with users from two or more different organizations (e.g., associated with different organization identifiers).

In at least one example, each workspace can be associated with a different indicator 202-206, presented via the first region 146. In at least one example, a user account of the user 200 (e.g., User F) can be associated with group identifiers that correspond to each of the workspaces (e.g., as determined by the user data 124 and/or the workspace data 128). As such, the user account of the user 200 can be associated with each of the workspaces. A first indicator 202 can represent a first workspace, a second indicator 204 can represent a second workspace, and a third indicator 206 can represent a third workspace.

In some examples, the user 200 can navigate between the workspaces by actuating a control associated with each of the indicators 202-206 without needing to log out of one workspace and log in to each of the other workspaces. Non-limiting examples of such indicators, or any indictors described herein, can include icons, symbols, links, tabs, or other user interface elements or objects. In some examples, such indicators can be associated with actuation mechanisms to enable a user to select an indicator and transition to another workspace. In some examples, a visual indicator can indicate which workspace a user is currently interacting with and/or most recently interacted with. For example, the second indicator 204 is outlined in a heavier weight than the first indicator 202 and the third indicator 206, thereby indicating which workspace the user is currently interacting with and/or most recently interacted with. In some examples, the indicators 202-206 can be associated with another indicator indicating that the corresponding workspace has been updated. An example is shown with respect to the third indicator 206.

While three indicators 202-206 are illustrated in FIG. 2, the user 200 can be associated with any number of workspaces. In some examples, indicators associated with all of the workspaces with which a user 200 is associated can be presented via the first region 146. In some examples, some of the indicators associated with all of the workspaces with which a user 200 is associated can be presented via the first region 146 and the user can interact with the user interface 144 to view additional or alternative indicators. In examples where fewer than all workspaces are represented via the user interface 144, the indicators can be arranged in alphabetical order, in an order of most recent interaction, in an order based on most frequent interaction, or some other order.

In some examples, the first region 146 may not be included in the user interface 144, and such information can be integrated into the user interface 144 via additional or alternative mechanisms.

In some examples, the user interface 144 can include a second region 148, or pane, that includes indicator(s) (e.g., user interface element(s) or object(s)) representing virtual space(s) associated with the workspace(s) with which the user (e.g., account of the user) is associated. IN some examples, the second region 148 can include indicator(s) representing virtual space(s) that are not associated with a particular workspace. For example, the user 200 can be associated with one or more communication channels, direct messaging instances, boards, audio and/or video communication interfaces, or the like that are independent of workspaces.

In at least one example, the second region 148 can include one or more sub-sections, or sub-panes, which can represent different virtual spaces. For example, a first sub-section 208 can include indicators representing virtual spaces that can aggregate data associated with a plurality of communication channels and/or workspaces. In at least one example, each virtual space can be associated with an indicator in the first sub-section 208. In some examples, an indicator can be associated with an actuation mechanism such that when actuated, can cause the application 140 to present data associated with the corresponding virtual space via the third region 150. In at least one example, a virtual space can be associated with all unread data associated with each of the workspaces with which the user is associated. That is, in some examples, if the user requests to access the virtual space associated with “unreads,” all data that has not been read (e.g., viewed) by the user can be presented in the third region 150, for example in a feed. In such examples, different types of events and/or actions, which can be associated with different communication channels and/or virtual spaces, can be presented via a same feed. In some examples, such data can be organized and/or is sortable by workspace, time, type of action, communication channel, user, or the like. In some examples, such data can be associated with an indication of which user (e.g., member of the communication channel) posted the message and/or performed an action.

In some examples, each virtual space can be associated with a same type of event and/or action. For example, “threads” can be associated with messages, files, etc. posted in threads to messages posted in a communication channel and “mentions and reactions” (e.g., “M & R”) can be associated with messages or threads where the user 200 (e.g., User F) has been mentioned (e.g., via a tag) or another user has reacted (e.g., via an emoji, reaction, or the like) to a message or thread posted by the user. That is, in some examples, same types of events and/or actions, which can be associated with different communication channels and/or virtual spaces, can be presented via a same feed. As with the “unreads” virtual space, data associated with such virtual spaces can be organized and/or is sortable by workspace, time, type of action, communication channel, user, or the like.

In at least one example, the second region 148 of the user interface 144 can include a second sub-section 210, or sub-pane, that includes indicators representing communication channels. In some examples, the communication channels can include public channels, private channels, shared channels (e.g., between groups or organizations), single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user may be associated with both workspaces, or may only be associated with one of the workspaces. In some examples, the communication channels represented can be associated with combinations of communication channels associated with a single workspace and communication channels associated with different workspaces.

In some examples, the second sub-section 210 can depict all communication channels, or a subset of all communication channels, that the user has permission to access (e.g., as determined by the user data 124, org data 126, and/or additional data 128). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the second sub-section 210 can depict all communication channels, or a subset of all communication channels, that the user is a member of, and the user can interact with the user interface 144 to browse or view other communication channels that the user is not a member of but are not currently displayed in the second sub-section 210. In some examples, different types of communication channels (e.g., public, private, shared, cross-workspace, etc.) can be in different sections of the second sub-section 210, or can have their own sub-regions or sub-panes in the user interface 144. In some examples, communication channels associated with different workspaces can be in different sections of the second sub-section 210, or can have their own regions or panes in the user interface 144.

In some examples, the indicators can be associated with graphical elements that visually differentiate types of communication channels. For example, Channel B is associated with a square visual element instead of a circle visual element. As a non-limiting example, and for the purpose of this discussion, the square visual element can indicate that the user is not a current member of Channel B, whereas the circle visual element can indicate that the user is a current member of Channels A, D, and N. In some examples, additional or alternative graphical elements can be used to differentiate between public communication channels, private communication channels, shared communication channels, communication channels associated with different workspaces, and the like. In other examples, communication channels that the user is not a current member of may not be displayed in the second sub-section 210 of the user interface 144. In such examples, the user may navigate to a different interface (not shown) to browse additional channels that are accessible to the user but to which the user is not currently a member.

In addition to the second sub-section 210, the second region 148 can include a third sub-section 212, or sub-pane, that can include indicators representative of communications with individual users or multiple specified users (e.g., instead of all, or a subset of, members of an organization). Such communications can be referred to as “direct messages” transmitted via “direct messaging instances.” That is, the third sub-section 212, or sub-pane, can include indicators representative of virtual spaces that are associated with private messages between one or more users.

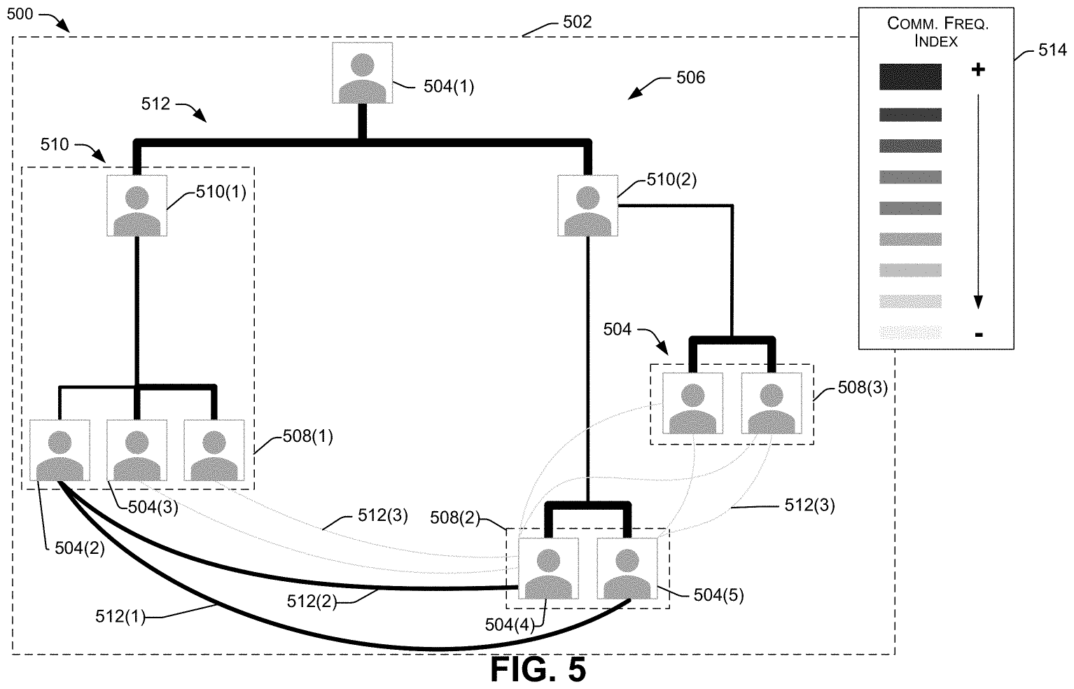

In various examples, the second region 148 can include an organization indicator 214, selectable to view data associated with an organization of the user 200. The data can include organizational data of the organization, which can, in some examples, include user data associated with one or more users of the organization. In some examples, the data can be presented in an organizational chart (e.g., organizational management structure) such as that depicted with respect to FIG. 5. In various examples, the organizational chart can be accessible to the user 200 responsive to a selection of an org chart selectable option 216. In such examples, responsive to receiving an indication of selection of the org selectable option, the server(s) 102 can cause the organizational chart to be presented via the third region.

In the illustrative example, the data is presented from a perspective of the user 200. In such an example, the data can provide the user 200 with up to date information associated with connections of the user 200. As a non-limiting example, the data can include manager data 218, department data 220, cost center data 222, and team data 224, though additional and/or alternate data is contemplated herein. In some examples, the manager data 218 can include data associated with a person to whom the user 200 reports, such as in a hierarchical or other structure of the organization. In the illustrative example, the manager data 218 includes a name, location, and next level manager (e.g., manager to whom the user's manager reports). In some examples, the manager data 218 can additionally or alternatively include contact information associated with the manager, such as a telephone number, an email address, a link to direct message the manager, or the like.

In some examples, the department data 220 can include data associated with a department associated with the user 200. In various examples, the department data 220 can include members and/or indicators associated with individual members of the department. In some examples, the indicators may be individually selectable, such as to send a message to the associated member of the department. In such examples, the indicators and/or the department data 220 can provide a means by which the user 200 can easily communicate with one or more other members of their department.

In some examples, the cost center data 222 can include data associated with a financial group associated with a department or team of the user 200. In various examples, the cost center data 222 can include a number of members and/or indicators associated with individual members of the cost center. In some examples, the indicators may be individually selectable, such as to send a message to the associated member of the cost center. In such examples, the cost center data 222 can provide a means by which the user 200 can easily communicate with one or more members of the financial group, such as to facilitate funding approvals, or the like.

In some examples, the team data 224 can include data associated with a team to which the user 200 is assigned. In various examples, the team data 224 can include a number of members and/or indicators associated with individual members of the team. In some examples, the indicators may be individually selectable, such as to send a message to the associated member of the team. In such examples, the team data 224 can provide a means by which the user 200 can easily communicate with one or more teammates, such as to welcome a new member to the team.

Additionally or alternatively, and as illustrated above with regard to FIG. 1, the third region 150 can be associated with a feed indicating messages posted to and/or actions taken with respect to a communication channel and/or other virtual space (e.g., a virtual space associated with direct message communication(s), a virtual space associated with event(s) and/or action(s), board(s), audio or video conversations(s), etc.) for facilitating communications. In some examples, the feed and the organizational data associated with the 214 can be presented concurrently, such as in a bifurcated third region 150 (e.g., including a first sub-region associated with the org data and a second sub-region associated with the feed). In such examples, the user 200 can reference organizational data concurrently with data associated with the feed. In some examples, the data presented in the feed can be organized and/or is sortable by workspace, time, type of action, communication channel, user, or the like. In some examples, such data can be associated with an indication of which user posted the message and/or performed an action. In examples where the third region 150 presents data associated with multiple workspaces, at least some data can be associated with an indication of which workspace the data is associated with.

For purposes of this discussion, a “message” can refer to any electronically generated digital object provided by a user 200 using the user computing device 104 and that is configured for display within a communication channel and/or other virtual space for facilitating communications (e.g., a virtual space associated with direct message communication(s), etc.) as described herein. A message may include any text, image, video, audio, emojis, GIFs, application ticket(s), links, or combination thereof provided by a user (using a user computing device). For instance, the user 200 may provide a message that includes text, as well as an image and a video, within the message as message contents. In such an example, the text, image, and video would comprise the message. Each message sent or posted to a communication channel, direct messaging instance, board, audio or video chat interface, or the like associated with the communication platform can include metadata comprising a date, time (e.g., timestamp), a sending user identifier, recipient identifier(s), a message identifier, message contents, a group identifier, a communication channel identifier, or the like. In at least one example, each of the foregoing identifiers may comprise American Standard Code for Information Interchange (ASCII) text, a pointer, a memory address, or the like.

In some examples, a user can comment on a message in a “thread.” A thread can be a message associated with another message that is not posted to a communication channel, but instead is maintained within an object associated with the original message. Messages and/or threads can be associated with file(s), emoji(s), app(s), etc. In some examples, the server(s) 102 (e.g., org interaction component 118) can weight messages posted in threads utilizing the techniques described above. In some examples, the messages posted in threads can be weighted based on an identification of user account data associated with one or more thread followers, contributors, and the like.

In at least one example, the user interface 144 can include a search mechanism 226, wherein a user can input a search term and the server(s) 102 can perform a search associated with the communication platform. In some examples, the search can be performed across each workspace with which the user is associated, or the search can be restricted to a particular workspace, based on a user specification.

The user interface 144 is a non-limiting example of a user interface that can be presented via the user computing device 104 (e.g., by the application 140). In some examples, the application 140 can receive data from the messaging component 116 and/or org interaction component 118 and the application 140 can generate and present the user interface 144 based on the data. In other examples, the application 140 can receive data and instructions for generating the user interface 144 from the org interaction component 118. In such an example, the application 140 can present the user interface 144 based on the instructions. Additional or alternative data can be presented via a user interface and additional or alternative configurations can be imagined.

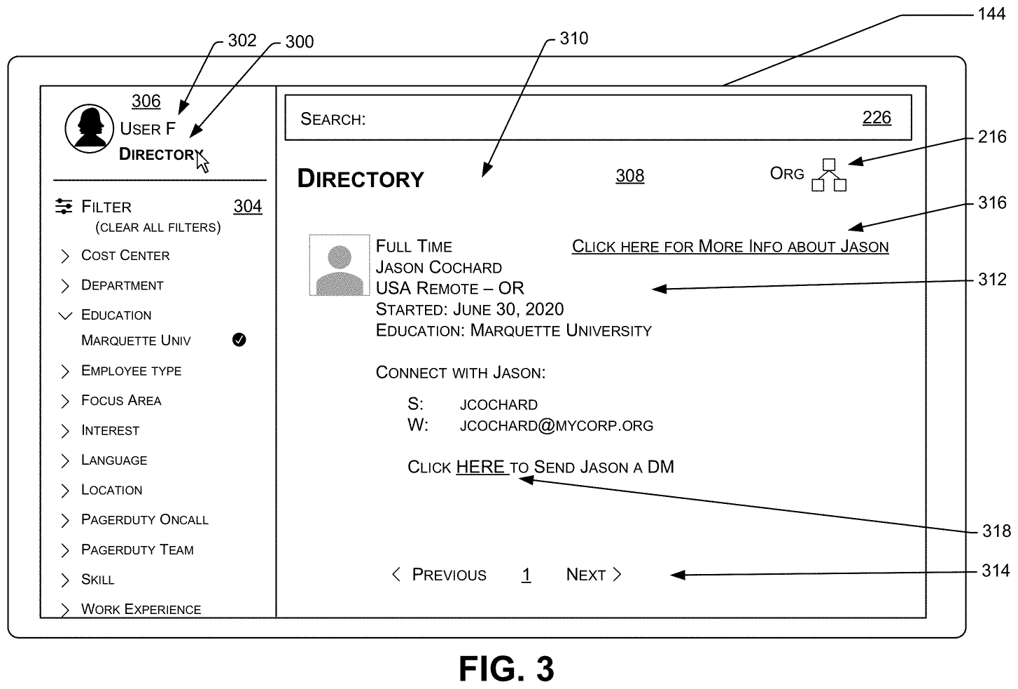

FIG. 3 illustrates an example user interface 144 for accessing data associated with members of an organization based on one or more attributes thereof. In some examples, the user interface 144 can include a directory selectable option 300 that enables a user 302, such as user 200, to access a directory including data associated with one or more members of an organization of the user 302. In some examples, the directory can include data associated with one or more members of other organizations, such as those connected to the organization of the user 302 (e.g., independent contractor, consultant, etc.).

In various examples, in response to receiving an indication of selection of the directory selectable option 300, the server(s) 102 can cause one or more filters 304 to be presented to via the user interface 144. In the illustrative example, the filter(s) 304 are presented in a first region 306 of the user interface 144, which may correspond to the second region 148 described above. In other examples, the filter(s) 304 can be presented in another region of the user interface 144, such as a second region 308, which may correspond to the third region 150 described above.

In various examples, the filter(s) 304 can each be associated with different attributes of a user. The attributes of the user can be determined based on user data 124, such as that stored in association with a user account, and/or org data 126, such as that stored in association with the organization. As a non-limiting example, the attributes can include an associated cost center, department, educational institution, employee type, focus area, interest, language, location, on-call time, on-call team, skill, work experience, and the like. In at least one example, the filter(s) 304 can provide the user 302 with a means by which the user 302 can filter through a directory of members of an organization to find other users with particular attributes. In the illustrative example, the server(s) 102 can receive an input via the user interface 144 that corresponds to an education filter 304, in which a user 302 seeks one or more users associated with Marquette University, such as having received a degree therefrom.

In various examples, in response to receiving an indication of selection of the directory selectable option 300 and/or receiving an input with regard to one or more filters, the server(s) 102 can cause a directory page 310 to be presented in a second region of the user interface 144. Though illustrated as encompassing an entirety of the second region 308, this is not intended to be so limiting and the directory page 310 may be presented in conjunction with a messaging feed (e.g., associated with one or more channels, one or more workspaces, one or more direct messaging instances, etc.), such as in a bifurcated presentation.

Additionally, in response to receiving an indication of selection of the directory selectable option 300 and/or receiving an input with regard to one or more filters, the server(s) 102 can identify one or more users associated with a request to view user data (e.g., indication of selection of the directory selectable option 300, input associated with the filter(s) 304, etc.). In various examples, the server(s) 102 can cause a presentation of the results (e.g., identified user(s)) via the directory page 310. In the illustrative example, the results include a single user. In other examples, a greater or lesser number of users that match the filter 304 criteria may be presented. For example, the server(s) 102 can search a directory of an organization based on the filter(s) 304 and not find a single user that matches the criteria. The server(s) 102 can cause a notification to be presented via the second region 308 indicating that no results were found, such as “no users associated with this organization match the search criteria.” For another example, the server(s) 102 can identify two or more users with associated user data that matches filter criteria. The server(s) 102 can present the two or more identified users via the directory page 310.

In some examples, server(s) 102 can present results associated with each identified user on a single directory page 310, such as in a list. In such examples, each identified user or indicator associated therewith can be selectable to view additional details (e.g., user data) associated with an identified user. In some examples, the server(s) 102 can present user data 312 associated with each identified user on an individual directory page 310. In such examples, the directory page 310 can include scrolling options 314, such as an indication of a page number (or identified user) the user 302 is currently viewing, an option to proceed to a next page including user data 312 associated with one or more additional identified users, and an option to return to a previously viewed page.

As illustrated in FIG. 3, the directory page 310 can include user data 312 associated with one or more identified users. In the illustrative example, the user data 312 presented via the directory page 310 includes a name of the identified user (illustrated as Jason Cochard), an associated country, state, working location (e.g., office, remote), working status (e.g., full time, part-time, etc.), a start date, education, and contact information. In some examples, the user data 312 can additionally or alternatively include a time of employment, one or more associated skills, work experience, preferred language, department, focus areas, contact information, and/or any other data stored in a database, such as in user data 124 of datastore 122.

In some examples, the user data 312 presented via the directory page 310 may include data associated with the filter(s) 304. For example, based on a determination that the user 302 input a filter 304 associated with education, the server(s) 102 can cause education data associated with the identified user to be presented via the directory page 310. In some examples, the directory page 310 can include an additional details selectable option 316, which can be selectable to view more information about the identified user. In some examples, the additional details selectable option 316 can include a link to a file, resume, or other document including additional details about the identified user.

In the illustrative example, the user data 312 can include contact information. Though illustrated as including a username associated with the communication platform and a work email address, this is not intended to be so limiting, and additional contact information is contemplated herein. For example, the contact information can include a physical address, work telephone number, mobile telephone number, social media handle, associated hashtags, and the like. In various examples, the directory page may include a contact selectable option 318 configured to enable the user 302 to quickly establish communication with the identified user via a message, such as via a direct messaging instance, a private channel, or the like.

In the illustrative example, the directory page 310 includes org chart selectable option 216. As described above, the org chart selectable option 216 can be selectable to cause an organizational chart to be presented via the second region 308 of the user interface 144. In various examples, responsive to receiving an indication of selection of the org chart selectable option 216, the server(s) 102 can present the organizational chart with an indication of where the identified user is located therein.

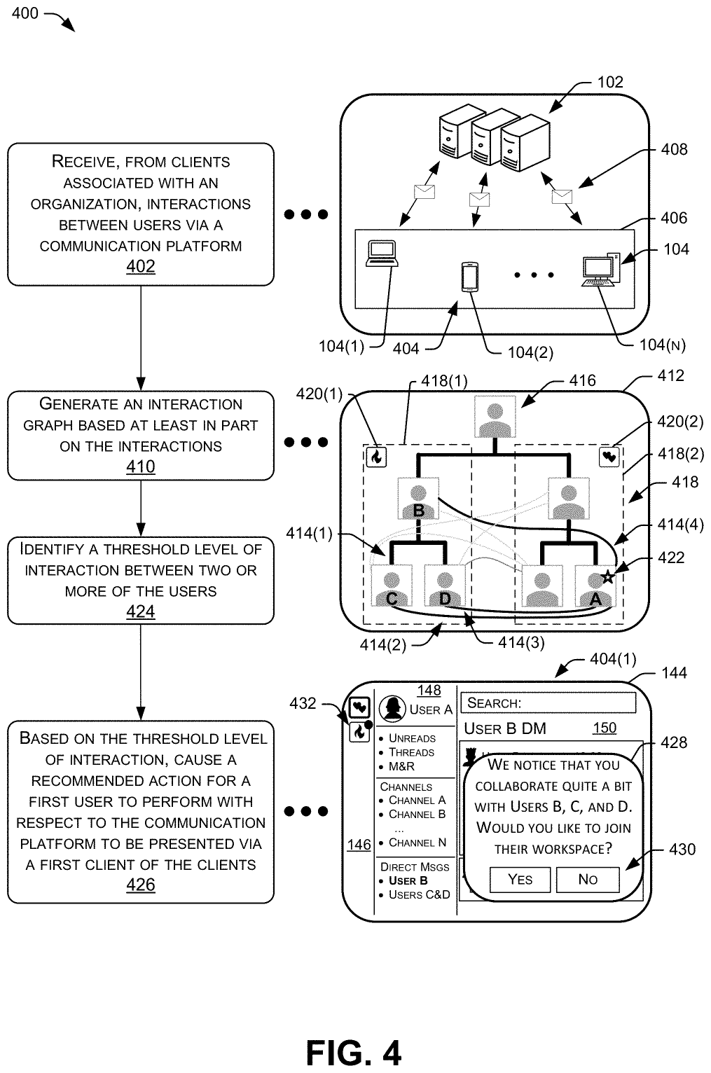

FIG. 4 illustrates an example process 400 for providing a recommended action for a user of an organization to perform based on communications within the organization, as described herein.

At operation 402, a server 102 receives, from clients 404 associated with an organization 406, interactions between users via a communication platform. In some examples, the interactions can be messages 408 including various types of content, such as text, emojis, reactjis, GIFs, links (e.g., hyperlink to a website, hyperlink to a collaborative document), third-party application tickets (e.g., applications used as collaborative tools, etc.), and the like. The messages 408 can be transmitted via channels, direct messaging instances, calls, audio and/or video communication interfaces, and the like shared between clients. The clients can include instances of an application 140 associated with one or more user computing devices 104. For example, a first computing device 104(1), a second computing device 104(2), and an nth computing device 104(n) can each have one or more clients 404 associated therewith.

As discussed above, the messages 408 can be transmitted between two or more users via channels, direct messaging instances, boards, audio and/or video communication interfaces, or the like of the communication platform. The messages can include text, emojis, reactjis, files (e.g., documents, photographs, etc.), links (e.g., hyperlink to a website, hyperlink to a collaborative document), third-party application tickets (e.g., applications used as collaborative tools, etc.), and the like. Additionally, each of the messages can include associated metadata, such as a sending user identifier, recipient identifier(s), a message identifier, message contents, a group identifier (e.g., workspace identifier, board identifier, audio and/or video communication interface identifier, etc.), a communication channel identifier, thread identifier (which may be the same or different from an associated communication channel identifier), direct message instance identifier, or the like. In at least one example, each of the foregoing identifiers may comprise American Standard Code for Information Interchange (ASCII) text, a pointer, a memory address, or the like.

At operation 410, the server 102 generates an interaction graph 412 based at least in part on the messages 408. The interaction graph 412 can represent communications and data flow between users of an organization. In various examples, the interaction graph can represent collaborations and/or working relationships between users of the organization 406. In such examples, the interaction graph 412 can represent how work is actually being completed within an organization 406.

In some examples, the interaction graph 412 can include a representation of a frequency of messages and/or associated weights of the messages (e.g., data) transmitted between the users. As discussed above, the server 102 can assign a weight to each message 408 transmitted between users of an organization. As non-limiting examples, the weight can be determined based on a number of words, an identified topic, keywords (e.g., work-related words, project-related words, etc.), symbols (e.g., question marks, exclamation marks, dollar signs, etc.), mentions or names included (e.g., @mention of another user, names of other users, etc.), a number of reactions to a message, types of links or applications associated with a message, files attached or associated with the message, times (e.g., timestamps) associated with messages (e.g., initial message, response time, etc.), and the like. In other words, the weight of a message can be determined based in part on a context and/or content associated therewith.

The interaction graph 412 of FIG. 4 includes lines 414 of varying thicknesses (e.g., lineweight) and line colors that represent a frequency and/or associated weights of the messages transmitted between the users 416. In at least one example, the thickness and/or colors of the lines 414 may represent an aggregated frequency and/or weight of the messages transmitted between users 416. In other examples, the interaction graph 412 can include another type of illustration of interactions, such as a heat map that represents the frequency and/or associated weights of the messages 408 transmitted between users 416, or the like. In some examples, the interaction graph 412 can represent the communications across an entire organization 406 and/or between two or more organizations. In some examples, the interaction graph 412 can represent the communications and data flow associated with a particular team, workspace, and/or communication channel, such as a representation of a frequency of messages and respective response times thereto.

In the illustrative example, the interaction graph 412 includes an organization 406 including two teams 418 each comprising respective groups of users. For purposes of this discussion, a “team” can include a group of users assigned to a particular work product, project, action, or the like within an organization 406. In some examples, each team 418 can include one or more associated workspaces 420. For example, a first team 418(1) can have associated therewith a first workspace 420(1) and a second team 418(2) can have associated therewith a second workspace 420(2), though this is merely an illustrative example and each team can include a greater or lesser number of associated workspaces. In various examples, the workspace(s) 420 associated with each team 418 can represent one or more virtual spaces for collaboration between group members. For example, Users B, C, and D associated with the first team 418(1) collaborate frequently (as represented by a first line 414(1)) within the first workspace 420(1).

In some examples, the interaction graph 412 can include a representation of a frequency and/or associated weights of messages 408 sent by a particular user 416. In such examples, the interaction graph 412 can represent a level of effectiveness and/or a professional contribution that the particular user adds to a team and/or an organization. For example, the interaction graph 412 can provide a visual representation of a level of contribution that User A provides to both the second team 418(2) of which User A is a member and also to the first team of which User A is not a member. For example, line 414(2) between User A and User C, line 414(3) between User A and User C, and line 414(4) between User A and User B indicate that User A communicates frequently and/or shares messages with significant weight with both Users B, C, and D of the first team 418(1). Accordingly, the interaction graph 412 indicates that a professional contribution provided by User A, within the second team 418(2) and to the first team 418(1) is greater than other users of the organization 406.

In some examples, the server 102 can determine that a contribution of a particular user 416 to a team 418 and/or an organization 406 is above a threshold level. In some examples, the contribution can include an aggregate of the weights and/or frequencies of messages 408 sent by the particular user 416. In some examples, the server 102 can include an indicator 422 in the interaction graph 412 in association with the particular user 416 indicating the contribution that is above the threshold level. In such examples, a user viewing the interaction graph 412 can easily determine one or more users 416 that contribute more than a threshold amount to the team 418 and/or organization. In the illustrative example, the indicator 422 includes a star shape. In other examples, the indicator 422 can be presented as a different font, color, symbol, shape, or the like.

At operation 424, the server 102 identifies a threshold level of interaction between two or more users 416 of the organization 406. In various examples, the threshold level of interaction can include an unexpected level of interaction between the user(s) 416. The threshold level of interaction can be determined based on team 418 and/or workspace 420 association, a position or title of a user 416 and/or other user data, organizational data or the like. In other words, the server 102 can determine that two or more users 416 communicate more frequently and/or with more substantive information (e.g., sharing work-related collaboration tools) than what would be expected based on respective team memberships, positions, titles, etc. For example, the server 102 can determine a threshold level of interaction between User A and Users C and D based at least in part on the association of User A with the second team 418(2) and/or second workspace 420(2) and Users C and D with the first team 418(1) and/or the first workspace 420(1). For another example, the server 102 can determine a threshold level of interaction between User A and User B based at least in part on User B being associated with a managerial position in the first team 418(1) and User A being associated with a subordinate position in the second team 418(2).

At operation 426, the server 102, based on the threshold level of interaction, causes a recommended action 428 for a first user to perform with respect to the communication platform to be presented via a first client 404(1) of the clients 404. In the illustrative example, the recommended action 428 includes a pop-up notification presented via a third region 150 of a user interface 144 of the first client 404. As discussed above, the first client 404(1) can be associated with a user computing device 104, such as an instance of an application 140 associated with the user computing device 104. In other examples, the recommended action 428 can be presented as an automated message associated with a channel, direct message or other method of communication between the user(s) 416 associated with the threshold level of interaction. Though illustrated as being presented on a client 404(1) associated with User A, this is not intended to be so limiting, and the recommended action 428 can be presented on one or more other clients associated with Users B, C, and/or D, such as in a recommendation to invite User A to join the first workspace 420(1), to generate a channel, board, and/or audio and/or video communication interface for collaboration between Users A, B, C, and/or D, or the like.

In the illustrative example, the recommended action 428 includes a recommendation to join the first workspace 420(1) associated with the other users (e.g., Users B, C, and D). As discussed above, the recommended action 428 can additionally or alternatively include a recommendation to invite the other users to the second workspace 420(2) associated with User A, to modify permissions with regard to the first workspace 420(1) to grant User A permissions to access the first workspace 420(1), to generate a new channel, multi-person direct messaging instance, a board, or an audio and/or video communication interface, to utilize collaborative applications within the communication platform, to hire additional users (e.g., based on a determination that the collaboration with User A is based in part on the first team 418(1) being understaffed), or the like. For example, the recommended action 428 can be presented on a client associated with User B, a manager of the first team 418(1), to modify permissions associated with the first workspace 420(1) to enable User A to access the first workspace 420(1).

In various examples, the recommended action 428 can include selectable options 430 to enable the associated user 416 the ability to accept or deny the recommended action 428. For example, the recommended action 428 can include suggestion for User A to join the first workspace 420(1) and the selectable options 430 include a “Yes” option to accept the recommended action 428 and a “No” option to deny the recommended action 428. Though other selectable options 430 are contemplated herein, such as “not at this time,” “request permission to join,” “identify other users who can help.” For example, the recommended action 428 can include a recommendation to User B to associate additional people with the first team 418(1) due a determination that the first team 418(1) is understaffed. The recommended action 428 can include a selectable option 430 to access an organization chart and/or directory page, such as directory page 310 with associated filters 304 that can enable User B to search for one or more other employees of the organization 406 who are qualified (e.g., have the work experience, skill, education, etc.) to augment the first team 418(1).

In response to receiving an indication of acceptance of the recommended action 428, such as via a “Yes” selectable option 430, the server 102 can associate User A with the first workspace 420(1). In some examples, the server 102 can cause an indicator 432 (e.g., indicator 202, indicator 204, or indicator 206) associated with the first workspace 420(1) to be presented in a first region 146 of the user interface 144. In other examples, the indicator can be presented in another region, such as the second region 148 or third region 150 of the user interface 144.

FIG. 5 illustrates an example interaction graph 500, such as interaction graph 412, associated with communications within an organization 502, such as organization 406, as described herein. As discussed above, the interaction graph 500 can represent communications and data flow between members 504 (e.g., users 504) of the organization 502, based on messages sent via a communication platform. In the illustrative example, the interaction graph 500 is presented in association with an organizational chart 506 or structure associated with the organization 502. In other words, the interaction graph 500 provides an illustrative representation of communications between members in association with respective positions associated therewith within the organization 502. In other examples, the interaction graph 500 can be presented in a graphical format, a ranked list of communicators (e.g., users associated with most frequent communications, most data intensive (e.g., data rich, highest weights, etc.) communications, etc.), or other format configured to represent communications and/or data flow within the organization 502.

The organizational chart 506 can represent an organizational management structure associated with the organization 502. In the illustrative example, the organizational chart 506 includes a hierarchical structure, such as with a first user 504(1) at the top of the hierarchical structure, and other users, such as second user 504(2), third user 504(3), fourth user 504(4), and fifth user 504(5) two levels below the first user 504(1). However, this is just an illustrative example, and greater or fewer levels of an organizational management structure are contemplated herein.

In various examples, the organization 502 can include one or more teams 508, each of which including one or more members 504. For example, a first team 508(1) includes three members, a second team 508(2) includes two members 504, and a third team 508(3) includes two members, but this is merely an example and is not intended to be so limiting. In some examples, each team 508 can have a manager 510 associated therewith. Though illustrated as being in a hierarchical position, this is merely for illustrative purposes, and the manager 510 can be a regular team member 504 with one or more administrative roles, such as a hiring leader, payroll coordinator, or the like. In some examples, the manager can be associated with one or more teams 508. For example, a first manager 510(1) is associated with a first team 508(1) and a second manager 510(2) is associated with a second team 508(2) and the third team 508(3). In some examples, the manager 510 can be a member of a team 508, such as a contributing member on a collaborative project, or can be separate from the team 508, such as in an administrative roll or the like. For example, a first manager 510(1) is depicted as being a member 504 of the first team 508(1) (e.g., within the structure of the team illustrated by the dashed line) and a second manager 510(2) is depicted as being separate from the second team 508(2) and the third team 508(3) of which the manager is associated (e.g., in an administrative roll, human resources roll, or the like).

As discussed above, the interaction graph 500 can include a representation of a frequency of messages and/or associated weights of the messages (e.g., data) transmitted between the users. As discussed above, the server 102 can assign a weight to each message transmitted between users 504 of an organization 502. As non-limiting examples, the weight can be determined based on a number of words, an identified topic, keywords (e.g., work-related words, project-related words, etc.), symbols (e.g., question marks, exclamation marks, dollar signs, etc.), mentions or names included (e.g., @mention of another user, names of other users, etc.), a number of reactions to a message, types of links or applications associated with a message, files attached or associated with the message, times (e.g., timestamps) associated with messages (e.g., initial message, response time, etc.), and the like. In other words, the weight of a message can be determined based in part on a context and/or content associated therewith.

In the illustrative example, the frequency and/or weights of messages can be represented by lines 512, each of which are representative of an aggregation of the frequency and/or weights of messages transmitted between at least two users 504. In some examples, the interaction graph 500 can include a communication frequency index 514, which indicates the frequency and/or weights of communications. For example, a dark, thick line 512 can represent a higher frequency and/or weight of communication between at least two users 504 and a light, thin line 512 can represent a lower frequency and/or weight of communication. In some examples, a thickness of the line 512 can represent an aggregated weight associated with the communications and the color of the line 512 can represent a frequency of communications, or vice versa. In some examples, the thickness and/or color of the line 512 can represent an aggregation of both frequency and weight associated with the messages.

In some examples, the lines 512 associated with a particular user 504 can represent a level of collaboration with the particular user 504 with one or more other users of the organization 502. For example, a first line 512(1) can indicate, based on a thickness and/or color, that a second user 504(2) collaborates at a first level with a fourth user 504(4) and a third line 512(3) can indicate that a third user 504(3) collaborates at a second level with the fourth user 504(4), the second level being less than the first level.

As discussed above, the server 102 can identify one or more threshold levels of interaction between users 504 based in part on the interaction graph 500. In various examples, the threshold level of interaction can include an unexpected level of interaction between the user(s) 504. The threshold level of interaction can be determined based on team 508 and/or workspace association, a position or title of a user 504 and/or other user data, organizational data or the like. In some examples, the server 102 can determine that user(s) 504 communicate more frequently and/or with more substantive information (e.g., sharing work-related collaboration tools) than what would be expected based on respective team memberships, positions, titles, etc. (e.g., that the level of interaction meets or exceeds a threshold level of interaction). For example, a first line 512(1) and a second line 512(2) can indicate, based on a thickness and/or color, that a second user 504(2) of a first team 508(1) collaborates often and/or substantively with a fourth user 504(4) and a fifth user 504(5) of a second team 508(2), such as that indicative of often sharing application tickets, project related data, or the like. Based at least in part on the different (e.g., distinct and separate) team membership between the second user 504(2) and the fourth user 504(4) and the fifth user 504(5), the server can determine that a level of interaction between the second user 504(2) and the fourth and fifth users 504(4) and 504(5), respectively, meets or exceeds a threshold level of interaction. For another example, a third line 512(3) can indicate a level of interaction between the third user 504(3) and the fourth user 504(4) that represents a minimal frequency and/or substance, such as that indicative of the third user 504(3) and the fourth user 504(4) occasionally sharing personal photos or messages.

In some examples, the server 102 can determine that user(s) 504 communicate less frequently and/or with less substantive information (e.g., sharing work-related collaboration tools) than what would be expected based on respective team memberships, positions, titles, etc. (e.g., that the level of interaction is less than a threshold level of interaction). For example, a second team 508(2) and a third team 508(3), both working under a same manager (e.g., second manager 510(2)) may each be assigned to a part of a project that the manager 510(2) leads. At least because the second team 508(2) and the third team 508(3) share a manager 510(2) and are working on the project, an expected threshold level of interaction may be set a particular level such that it would be expected for the teams 508 to collaborate frequently and/or substantively. Based on a determination that an actual level of interaction, such as that depicted in line 512(3) and the like, between the members of the second team 508(2) and the members of the third team 508(3) is less than the threshold level of interaction (e.g., the particular level), the server 102 can determine an unexpected level of interaction between the second team 508(2) and the third team 508(3).

In some examples, the threshold level of interaction can additionally or alternatively be determined based on a recency of affiliation with a particular user 504, group of users 504, team 508, or the like to the organization 502. In such examples, the server 102 can determine a threshold level of interaction based on a time associated with when the user(s) 504 and/or team 508 joined the organization 502 or became associated therewith. In some examples, by determining the threshold level of interaction based on the recency of association with the organization, the servers 102 can prevent one or more users 504 and/or teams 508 from being siloed from other users 504 and teams 508 of the organization 502. For example, the organization 502 can acquire a new company and the server 102 can add the team members of the new company to the organizational chart 506 (e.g., based on updated org data 126). The server 102 can determine a threshold level of interaction based on the recency of addition of the new team members to the organization and/or organizational chart 506, anticipating that other teams 508 and/or users 504 should communicate and/or collaborate with the recently added team 508 and/or users 504. For another example, the server 102 may determine that the third user 504(3) recently joined the first team 508(1). Accordingly, the server 102 may determine a threshold level of interaction between the third user 504(3) and the first manager 510(1), to ensure that the third user 504(3) is welcomed and receives sufficient guidance and assistance from the first manager 510(1).

As discussed above, based on the identification of the threshold level, the server 102 can identify one or more recommended actions for a user 504 to take. In some examples, the recommended action can include an action for a manager 510 to take with respect to a team 508 and/or permissions associated with one or more workspaces, channels, boards, or the like associated with the team 508. For example, based on a determination that a level of communication between the second member 504(2) of the first team 508(1) and the fourth member 504(4) of the second team meets or exceeds a threshold level of communication, the recommended action may include modifying permissions associated with a workspace of the first team 508(1) to grant access to the fourth member 504(4). In some examples, the recommended action can include an action for the manager 510 to take with respect to a particular user 504. For example, based on a determination that a level of interaction between a manager 510 and a new team member 504 is less than a threshold level of interaction, the recommended action can include sending a check-in message to the new team member 504 to ensure that they have everything needed to succeed with the team 508. Additional examples of recommended actions are described above and below.

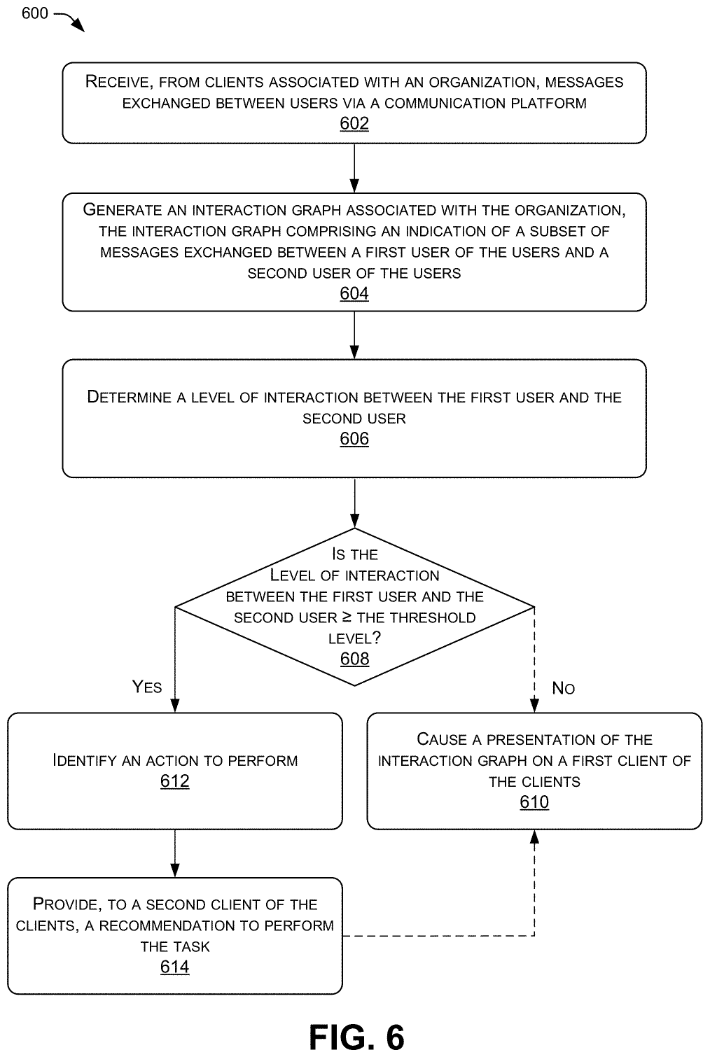

In FIGS. 4 and 6-10 are flowcharts showing example processes involving techniques as described herein. The processes illustrated in FIGS. 6-10 are described with reference to components described above with reference to the system 100 shown in FIG. 1 for convenience and ease of understanding. However, the processes illustrated in FIGS. 6-10 are not limited to being performed using the components described above with reference to the system 100. Moreover, the components described above with reference to the system 100 are not limited to performing the processes illustrated in FIGS. 6-10.

FIG. 6 illustrates another example process 600 for identifying an action to perform based on an unexpected level of interaction between members of an organization, as described herein.

At operation 602, a server 102 receives, from clients associated with an organization, messages exchanged between users via a communication platform. In various examples, the clients can include instances of a communication platform application (e.g., application 140) associated with a respective user computing device. In various examples, the messages can include messages transmitted between users of the organization and/or users of one or more other organizations.

In various examples, the messages can be transmitted via a communication channel (e.g., private, public, shared, etc.), in a thread associated with a communication channel, direct messaging instance, a board, an audio and/or video communication interface, or the like. The messages can include various types of content, such as text, emojis, reactjis, GIFs, links (e.g., hyperlink to a website, hyperlink to a collaborative document), third-party application tickets (e.g., applications used as collaborative tools, etc.), and the like.

At operation 604, the server 102 generates an interaction graph associated with the organization, the interaction graph comprising an indication of a subset of messages exchanged between a first user of the users and a second user of the users. In some examples, the first user and the second user can be associated with the same or different organizations. In some examples, the first user can be a sending user (or sender) of the message and the second user may be a receiving user (or recipient) of the message transmitted via the communication platform, or vice versa.

In various examples, the server 102 can receive the subset of messages and can determine (or assign) a weight associated with each message of the subset of messages. The weight can represent a level of importance, a level of collaborative effort, or the like, between the first user and the second user. In some examples, the weight may be determined based on a weighting factor (e.g., 1.05, 1.1, 1.2, etc.), such as to increase a weight based on a level of collaborative effort, level of importance, or the like of the message. As non-limiting examples, the weight and/or weighting factor can be determined based on a number of words, an identified topic, keywords (e.g., work-related words, project-related words, etc.), symbols (e.g., question marks, exclamation marks, dollar signs, etc.), mentions or names included (e.g., @mention of another user, names of other users, etc.), a number of reactions to a message, types of links or applications associated with a message, files attached or associated with the message, times (e.g., timestamps) associated with messages (e.g., initial message, response time, etc.), and the like. In other words, the weight of a message can be determined based in part on a context and/or content associated therewith.

In some examples, the weight can be determined based on whether the first user and the second user are associated with a same or a different organization. In such examples, the server 102 may apply a different weighting factor to messages with a same context or content based on an organizational association of each of the sender and one or more recipients. For example, the server 102 may determine to apply a first weighting factor of 1.1 to a message including a link to a collaborative document shared between members of an organization and a second weighting factor of 1.3 to a message including the link to the collaborative document shared between a member of a first organization and at least one member of a second organization.

At operation 606, the server 102 determines a level of interaction between the first user and the second user. The server 102 determines the level of interaction based on a frequency and weights associated with the subset of messages exchanged between the first user and the second user.

At operation 608, the server 102 determines whether the level of interaction between the first user and the second user meets or exceeds the threshold level of interaction. In various examples, the threshold level of interaction can represent an expected level of interaction between the first user and the second user. In some examples, the threshold level of interaction can be determined based on respective user identifiers, organizational identifiers, group identifiers, team identifiers, organizational data, user data, and the like. For example, the threshold level of interaction may be determined based on whether the first user and the second user are members of a same or different team in an organization. For another example, the threshold level of interaction may be determined based on whether the first user and the second user are members of a same or different organization. For yet another example, the threshold level of interaction may be determined based on whether the first user or the second user are new members of an organization, a team, or the like. For still yet another example, the threshold level of interaction may be determined based on positions associated with the first user and the second user in respective teams.

Based on a determination that the level of interaction is less than the threshold level of interaction (“No” at operation 608), the server 102, at operation 610, can optionally cause a presentation of the interaction graph on a first client of the clients (e.g., via a display of a first computing device associated with the organization). In some examples, the server 102 can cause the interaction graph to be presented via the first client in response to receiving a request to view the interaction graph. The interaction graph can include a visual depiction of the level of interaction between the first user and the second user. In some examples, the visual depiction may include a line of a thickness and/or color that indicates the level of interaction between the two users (and between other users of the organization). In some examples, the visual depiction may include a heat map that indicates the level of interaction between the two users (and between other users of the organization. As discussed above, the interaction graph can be presented in association with an organizational chart, such as to provide a visual indication of one or more relationships of users associated with the organization.

Based on a determination that the level of interaction meets or exceeds the threshold level of interaction (“Yes” at operation 608), the server 102, at operation 612 identifies an action to perform. The action can include a recommended action, such as that determined based on the level of interaction meeting or exceeding the threshold level of interaction. In some examples, the action can include a recommended action for the first user and/or the second user to perform. In some examples, the action can include a recommended action for a third user, such as a manager or administrator associated with the first user and/or the second user to perform. As discussed above, the action can include one or more recommended actions for a respective user to take with respect to the organization and/or the communication platform.

At operation 614, the server 102 provides, to a second client of the clients associated with the organization, a recommendation to perform the action. The recommendation may be presented via a message (e.g., automated message, bot message, etc.), a pop-up notification, text message, email, or the like. In some examples, the recommendation may include a selectable option to accept or deny the recommendation. In some examples, the accept selectable option may initiate a performance of the action. For example, the recommendation may include an action to modify permissions with regard to a workspace of the first user to allow the second user permissions to access data associated therewith. Responsive to receiving an indication of selection of the accept selectable option, the server 102 may automatically modify the permissions as recommended. Alternatively, the server 102 can launch a permissions page on the second client, enabling a viewing user to quickly and easily modify the permissions as recommended.

Additionally, the server 102 can optionally cause a presentation of the interaction graph on a first client of the clients, as described with respect to operation 608.

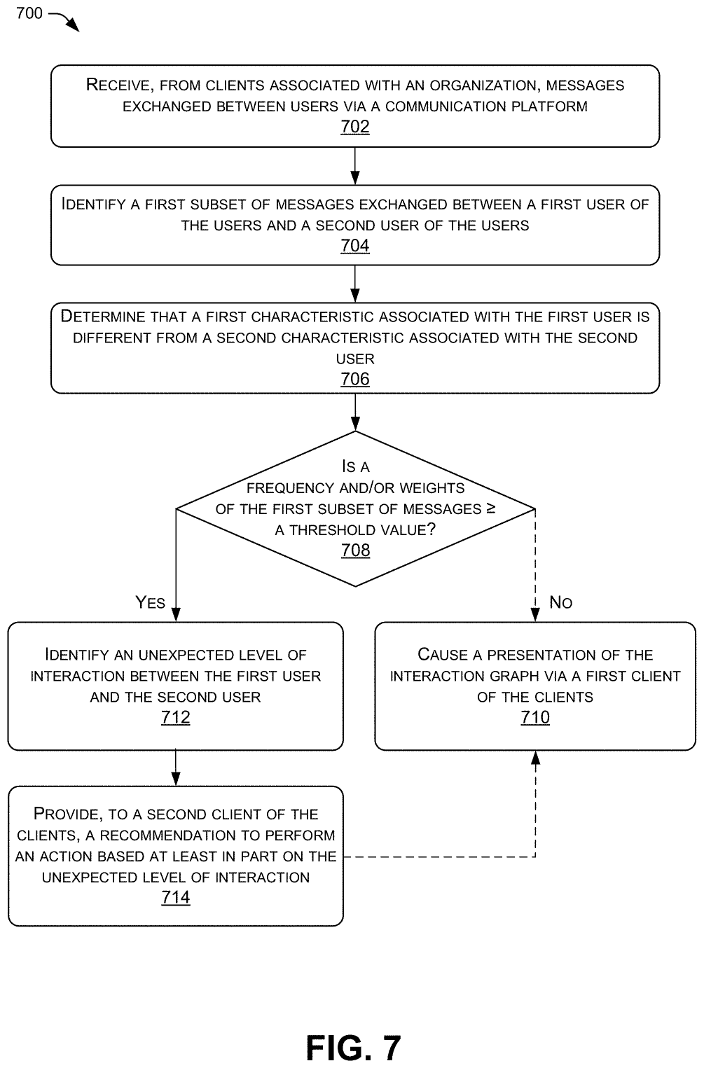

FIG. 7 illustrates an example process 700 for identifying an unexpected level of interaction between members of an organization based on assigned descriptors associated with the members, as described herein.

At operation 702, a server 102 receives, from clients associated with an organization, messages exchanged between users via a communication platform. In various examples, the clients can include instances of a communication platform application (e.g., application 140) associated with a respective user computing device. In various examples, the messages can include messages transmitted between users of the organization and/or users of one or more other organizations.

In various examples, the messages can be transmitted via a communication channel (e.g., private, public, shared, etc.), in a thread associated with a communication channel, direct messaging instance, a board, an audio and/or video communication interface, or the like. The messages can include various types of content, such as text, emojis, reactjis, GIFs, links (e.g., hyperlink to a website, hyperlink to a collaborative document), third-party application tickets (e.g., applications used as collaborative tools, etc.), and the like.

At operation 704, the server 102 generates an interaction graph associated with the organization, the interaction graph comprising an indication of a subset of messages exchanged between a first user of the users and a second user of the users. In some examples, the first user and the second user can be associated with the same or different organizations. In some examples, the first user can be a sending user (or sender) of the message and the second user may be a receiving user (or recipient) of the message transmitted via the communication platform, or vice versa.

In various examples, the server 102 can receive the subset of messages and can determine (or assign) a weight associated with each message of the subset of messages. The weight can represent a level of importance, a level of collaborative effort, or the like, between the first user and the second user. In some examples, the weight may be determined based on a weighting factor (e.g., 1.05, 1.1, 1.2, etc.), such as to increase a weight based on a level of collaborative effort, level of importance, or the like of the message. As non-limiting examples, the weight and/or weighting factor can be determined based on a number of words, an identified topic, keywords (e.g., work-related words, project-related words, etc.), symbols (e.g., question marks, exclamation marks, dollar signs, etc.), mentions or names included (e.g., @mention of another user, names of other users, etc.), a number of reactions to a message, types of links or applications associated with a message, files attached or associated with the message, times (e.g., timestamps) associated with messages (e.g., initial message, response time, etc.), and the like. In other words, the weight of a message can be determined based in part on a context and/or content associated therewith.

In some examples, the weight can be determined based on whether the first user and the second user are associated with a same or a different organization. In such examples, the server 102 may apply a different weighting factor to messages with a same context or content based on an organizational association of each of the sender and one or more recipients. For example, the server 102 may determine to apply a first weighting factor of 1.1 to a message including a link to a collaborative document shared between members of an organization and a second weighting factor of 1.3 to a message including the link to the collaborative document shared between a member of a first organization and at least one member of a second organization.

At operation 706, the server 102 determines that a first characteristic associated with the first user is different from a second characteristic associated with the second user. In some examples, the server 102 can determine the characteristics based on user data associated with the first user and the second user. In some examples, the characteristics can include respective physical locations, physical addresses, dates of hire, education, qualifications (e.g., skill, work experience, certificates, etc.), languages (e.g., preferred, additional fluency or languages understood, etc.), employment data (e.g., position, title, team association, reporting manager, etc.), etc.), team data (e.g., team members, team identifiers, associated projects, team expertise or focus areas, associated workspaces and/or channels, etc.), and the like. In at least one example, the characteristic can include respective positions or titles associated with the first user and the second user.

At operation 708, the server 102 determines whether a frequency and/or weights associated with the first subset of messages are at or above a threshold value. The threshold value may be determined based on the first characteristic and the second characteristic and/or a category thereof (e.g., position, title, education, qualification, location, etc.). In some examples, the server 102 can determine the threshold value based on respective user identifiers, organizational identifiers, group identifiers, team identifiers, organizational data, user data, and the like. For example, the threshold value may be determined based on whether the first user with a first characteristic of a manager and the second user with a characteristic associated with a position that is subordinate to a manager are members of a same organization, same team thereof. In other words, the threshold level can be determined based on whether the first user and the second user, based on their characteristics, would be expected to communicate often and/or substantively in a collaborative manner.

Based on a determination that the frequency and/or weights are less than the threshold value (“No” at operation 708), the server 102, at operation 710, can optionally cause a presentation of the interaction graph on a first client of the clients (e.g., via a display of a first computing device associated with the organization). In some examples, the server 102 can cause the interaction graph to be presented via the first client in response to receiving a request to view the interaction graph. The interaction graph can include a visual depiction of the level of interaction between the first user and the second user. In some examples, the visual depiction may include a line of a thickness and/or color that indicates the level of interaction between the two users (and between other users of the organization). In some examples, the visual depiction may include a heat map that indicates the level of interaction between the two users (and between other users of the organization. As discussed above, the interaction graph can be presented in association with an organizational chart, such as to provide a visual indication of one or more relationships of users associated with the organization.

Based on a determination that the frequency and/or weights meet or exceed the threshold value (“Yes” at operation 708), the server 102, at operation 712 identifies an unexpected level of interaction between the first user and the second user. The unexpected level of interaction can represent an actual level of interaction being above a threshold level of interaction (e.g., based on the threshold value), as described herein.

At operation 714, the server 102 provides, to a second client of the clients associated with the organization, a recommendation to perform an action based at least in part on the unexpected level of interaction. In some examples, the action can include a recommended action for the first user and/or the second user to perform. In some examples, the action can include a recommended action for a third user, such as a manager or administrator associated with the first user and/or the second user to perform. As discussed above, the action can include one or more recommended actions for a respective user to take with respect to the organization and/or the communication platform.

In various examples, the recommendation may be provided in a communication platform message (e.g., automated message, bot message, etc.), a pop-up notification, text message, email, or the like. In some examples, the recommendation may include a selectable option to accept or deny the recommendation. In some examples, the accept selectable option may initiate a performance of the action and/or cause the server 102 to automatically perform the action.

Additionally, the server 102 can optionally cause a presentation of the interaction graph on a first client of the clients, as described with respect to operation 710.

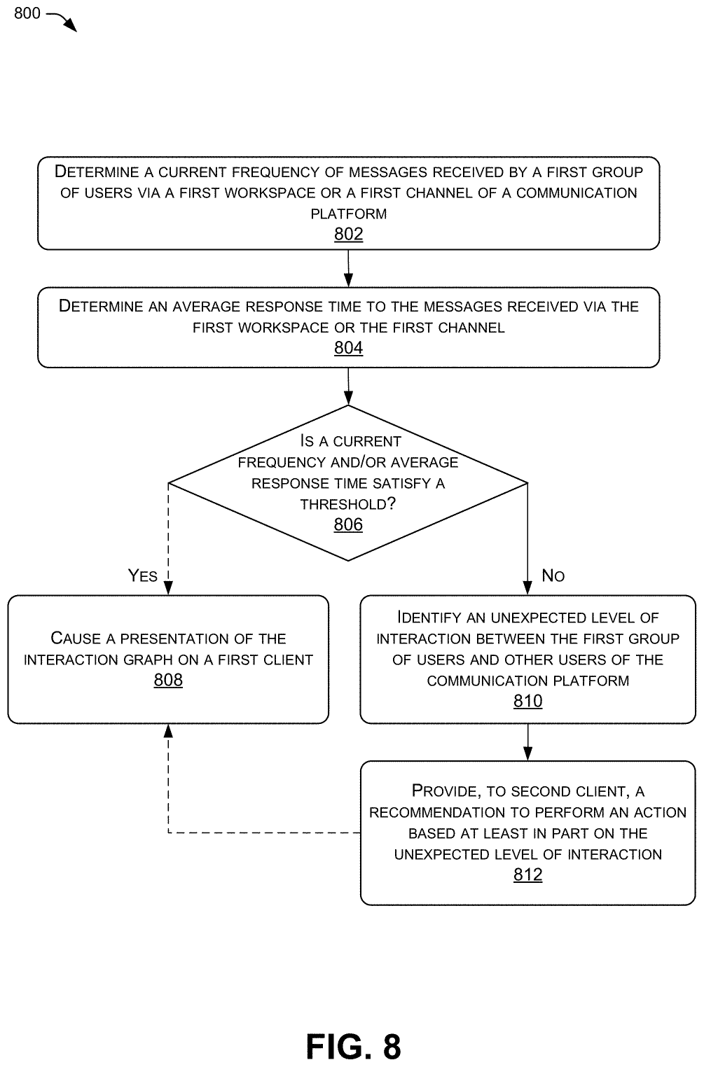

FIG. 8 illustrates an example process 800 for recommending an action to perform with respect to a group of users based on a frequency of messages received by the group of users being above a threshold frequency, as described herein.

At operation 802, the server 102 determines a current frequency of messages received by a first group of users via a first workspace or a first channel of a communication platform. In some examples, the current frequency can be associated with a current period of time, such as frequency within the last day, week, month, etc. In some examples, the current frequency of messages may provide an indication of a workload level associated with the first group of users. In such examples, the first workspace or the first channel can be associated with the first group of users performing actions, such as answering inquiries, providing help and/or other support, or the like. For example, a first workspace or a first channel can include an information technology (IT) triage workspace or channel associated with a help desk. The first group of users associated with the first workspace or the first channel may receive messages including requests for IT assistance.

At operation 804, the server determines an average response time to the messages received via the first workspace or the first channel. The average response time can include a response message transmitted from a user of the first group of users to a sending user of a message received via the first workspace or the first channel. Similar to that described above with regard to the current frequency of messages, the average response time can additionally or alternatively provide an indication of the workload level associated with the first group of users.

At operation 806, the server determines whether the current frequency and/or the average response time satisfy respective thresholds. The respective thresholds can represent threshold workloads associated with the first group of users, such as what first group of users can be expected to achieve (e.g., perform, complete, etc.) over a period of time (e.g., in a workday, in a work week, etc.). In some examples, the response time threshold can be determined based on a maximum response time associated with an inquiry, such as that determined by an organization. For example, at least because employees cannot perform functions if IT assets are not operating properly, an organization may set a threshold (maximum) response time to answer to an IP help desk request associated with an IT help desk channel to 5 minutes.

In some examples, a threshold frequency can be determined based on an average frequency of messages received via the first workspace or the first channel over a period of time that is greater than the period of time associated with the current frequency. In some examples, a threshold response time can be determined based on an average response time associated with responding to messages received via the workspace or channel. In some examples, the response time can be determine based on timestamps or other metadata associated with the messages received and corresponding response messages sent by a user of the first group of users.

Based on a determination that the current frequency and/or average response time satisfies respective thresholds (“Yes” at operation 806), the server 102, at operation 808, can optionally cause a presentation of the interaction graph on a first client (e.g., via a display of a first computing device associated with an organization). The first client can include a client that is associated with an organization corresponding to the first workspace or the first channel (e.g., owner, host, etc.). In some examples, the server 102 can cause the interaction graph to be presented via the first client in response to receiving a request to view the interaction graph. The interaction graph can include a visual depiction of the level of interaction between the first user and the second user. In some examples, the visual depiction may include a line of a thickness and/or color that indicates the level of interaction between the two users (and between other users of the organization). In some examples, the visual depiction may include a heat map that indicates the level of interaction between the two users (and between other users of the organization. As discussed above, the interaction graph can be presented in association with an organizational chart, such as to provide a visual indication of one or more relationships of users associated with the organization.

Based on a determination that the current frequency and/or average response time does not satisfy the respective thresholds (“No” at operation 806), the server 102, at operation 810 identifies an unexpected level of interaction between the first group of users and other users of the communication platform. In some examples, the unexpected level of interaction can represent an increased workload associated with the first group of users. In some examples, the unexpected level of interaction can represent a potential need to hire additional users to augment the first group of users for a period of time. Continuing the IT help desk example from above, based on a determination that an average response time is equal to or greater than 5 minutes, the server 102 determines an unexpected level of interaction that can indicate that the first workspace or first channel is understaffed.

At operation 812, the server 102 provides, to a second client, a recommendation to perform an action based at least in part on the unexpected level of interaction. In some examples, the action can include a recommended action for a user (e.g., manager of the first group of users, one of the first group of users, etc.) to perform with regard to the first workspace or the first channel. As non-limiting examples, the action may include generating an automated message to be pinned or otherwise presented via the first workspace or the first channel to indicate an increased frequency of inbound requests and/or an increased response time, hiring additional users to augment the first group of users, or the like. In various examples, the recommendation may be provided in a communication platform message (e.g., automated message, bot message, etc.), a pop-up notification, text message, email, or the like. In some examples, the recommendation may include a selectable option to accept or deny the recommendation. In some examples, the accept selectable option may initiate a performance of the action and/or cause the server 102 to automatically perform the action. For example, in response to receiving an indication of selection of the accept selectable option, the server 102 may automatically generate and present a delay message via the first workspace or the first channel.

Additionally, the server 102 can optionally cause a presentation of the interaction graph on a first client of the clients, as described with respect to operation 808.

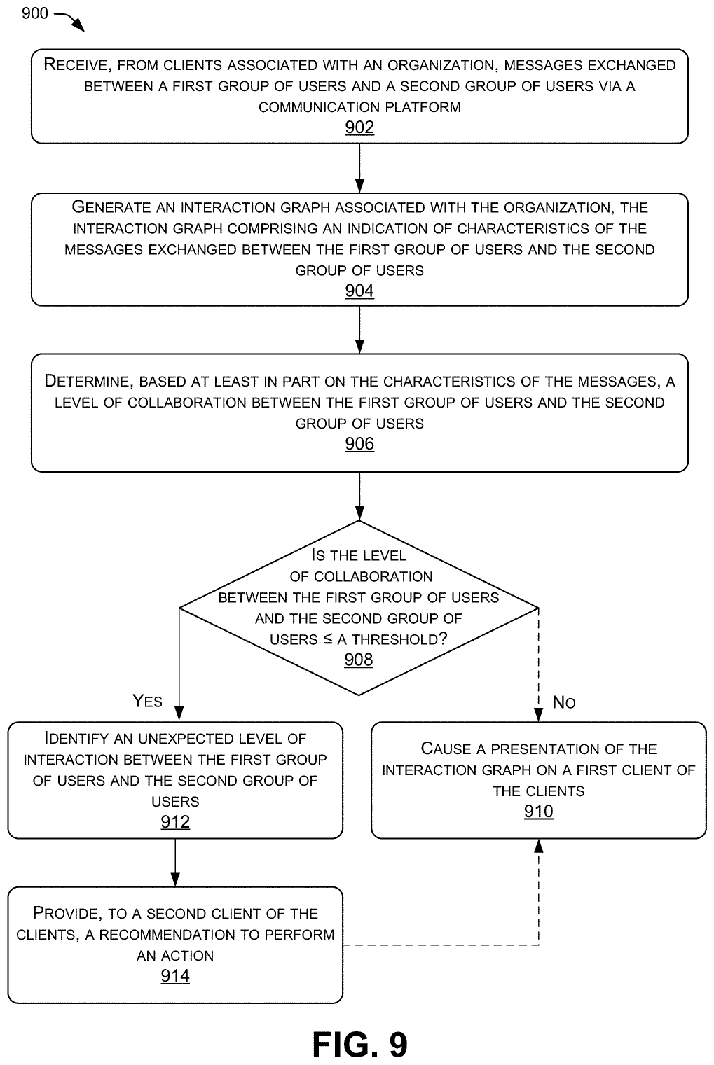

FIG. 9 illustrates an example process 900 for recommending an action to perform to increase collaboration between groups of users, as described herein.

At operation 902, a server 102 receives, from clients associated with an organization, messages exchanged between a first group of users and a second group of users via a communication platform. In various examples, the clients can include instances of a communication platform application (e.g., application 140) associated with a respective user computing device. In various examples, the messages can include messages transmitted between users of the organization and/or users of one or more other organizations.

In various examples, the messages can be transmitted via a communication channel (e.g., private, public, shared, etc.), in a thread associated with a communication channel, direct messaging instance, a board, an audio and/or video communication interface, or the like. The messages can include various types of content, such as text, emojis, reactjis, GIFs, links (e.g., hyperlink to a website, hyperlink to a collaborative document), third-party application tickets (e.g., applications used as collaborative tools, etc.), and the like.

At operation 904, the server 102 generates an interaction graph associated with the organization, the interaction graph comprising an indication of characteristics associated with the messages exchanged between a first group of users and a second group of users. In some examples, the first group of users and the second group of users can be associated with the same or different organizations.

In various examples, the server 102 can receive the messages and can determine (or assign) a weight associated with each message based on respective characteristics. The weight can represent a level of importance, a level of collaborative effort, or the like, between the first user and the second user. In some examples, the weight may be determined based on a weighting factor (e.g., 1.05, 1.1, 1.2, etc.), such as to increase a weight based on a level of collaborative effort, level of importance, or the like of the message. As non-limiting examples, the characteristics can include on a number of words, an identified topic, keywords (e.g., work-related words, project-related words, etc.), symbols (e.g., question marks, exclamation marks, dollar signs, etc.), mentions or names included (e.g., @mention of another user, names of other users, etc.), a number of reactions to a message, types of links or applications associated with a message, files attached or associated with the message, times (e.g., timestamps) associated with messages (e.g., initial message, response time, etc.), and the like. In other words, a weight of a message assigned based on characteristics can be determined based in part on a context and/or content associated therewith.

At operation 906, the server 102 determines, based at least in part on the characteristics of the messages, a level of collaboration between the first group of users and the second group of users. The level of collaboration can include a level of interaction between the two groups of users. In some examples, the level of collaboration can include a level of substantive or frequent level of interaction between the two. In some examples, the level of collaboration can be determined based on the weights associated with the messages. In such examples, the level of collaboration can be determined based on the contents and/or context of the messages. For example, a first level of collaboration between two groups that occasionally exchange third-party application tickets can be greater than a second level of collaboration between two groups that do not share third-party application tickets.

At operation 908, the server 102 determines whether the level of collaboration between the first group of users and the second group of users is less than a threshold. The threshold may be determined based on an expected level of collaboration between the groups, such as based on a shared manager, collaborative project, or the like. In some examples, the server 102 can determine the threshold based on organizational identifiers, group identifiers, team identifiers, organizational data, user data, and the like. For example, the threshold may be determined based on a determination that the first group of users and the second group of users are each assigned to respective portions of a project. Based on the project, the server 102 determines the threshold level of collaboration between the two groups.

Based on a determination that the level of collaboration is equal to or greater than the threshold (“No” at operation 908), the server 102, at operation 910, can optionally cause a presentation of the interaction graph on a first client of the clients (e.g., via a display of a first computing device associated with the organization). In some examples, the server 102 can cause the interaction graph to be presented via the first client in response to receiving a request to view the interaction graph. The interaction graph can include a visual depiction of the level of interaction between the first user and the second user. In some examples, the visual depiction may include a line of a thickness and/or color that indicates the level of interaction between the two users (and between other users of the organization). In some examples, the visual depiction may include a heat map that indicates the level of interaction and/or collaboration between individual users and/or groups of users. As discussed above, the interaction graph can be presented in association with an organizational chart, such as to provide a visual indication of one or more relationships of users associated with the organization.

Based on a determination that the level of collaboration is less than the threshold value (“Yes” at operation 908), the server 102, at operation 912 identifies an unexpected level of interaction between the first group of users and the second group of users. The unexpected level of interaction can represent an actual level of collaboration being less than the threshold level of collaboration, as described herein.

At operation 914, the server 102 provides, to a second client of the clients associated with the organization, a recommendation to perform an action based at least in part on the unexpected level of interaction. In some examples, the action can include a recommended action for a user associated with the first group of users and/or the second group of users to perform. In some examples, the action can include a recommended action for another user to perform (e.g., a user not associated with either the first group of users or the second group of users). As discussed above, the action can include one or more recommended actions for a respective user to take with respect to the organization and/or the communication platform. For example, the recommended action can include scheduling a meeting between at least a portion of the first group of users and at least a portion of the second group of users to encourage interaction and collaboration between the two groups of users.

In various examples, the recommendation may be provided in a communication platform message (e.g., automated message, bot message, etc.), a pop-up notification, text message, email, or the like. In some examples, the recommendation may include a selectable option to accept or deny the recommendation. In some examples, the accept selectable option may initiate a performance of the action and/or cause the server 102 to automatically perform the action.

Additionally, the server 102 can optionally cause a presentation of the interaction graph on a first client of the clients, as described with respect to operation 910.

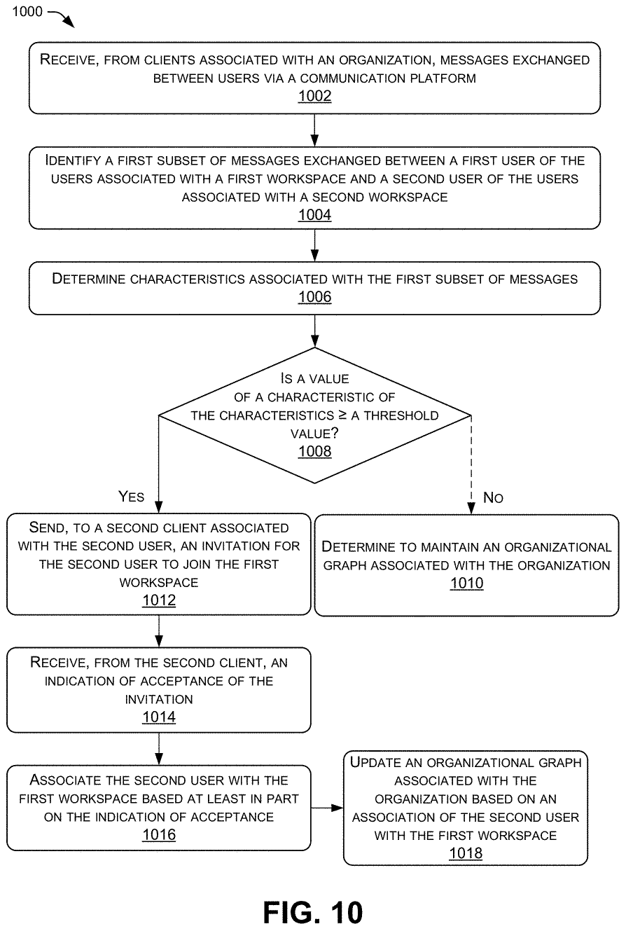

FIG. 10 illustrates an example process 1000 for updating an organizational graph based on communications between members of an organization, as described herein.

At operation 1002, the server 102 receives, from clients associated with an organization, messages exchanged between users via a communication platform. In various examples, the clients can include instances of a communication platform application (e.g., application 140) associated with a respective user computing device. In various examples, the messages can include messages transmitted between users of the organization and/or users of one or more other organizations.

In various examples, the messages can be transmitted via a communication channel (e.g., private, public, shared, etc.), in a thread associated with a communication channel, direct messaging instance, a board, an audio and/or video communication interface, or the like. The messages can include various types of content, such as text, emojis, reactjis, GIFs, links (e.g., hyperlink to a web site, hyperlink to a collaborative document), third-party application tickets (e.g., applications used as collaborative tools, etc.), and the like.

At operation 1004, the server 102 identifies a first subset of messages exchanged between a first user of the users associated with a first workspace and a second user of the users associated with a second workspace. In some examples, server 102 identifies the first subset of messages based at least in part on identifiers associated therewith, such as sending user identifiers, receiving user identifiers, communication channel identifiers, and the like.

At operation 1006, the server 102 determines characteristics associated with the first subset of messages. In various examples, the characteristics associated with the first subset of messages can include a weight of each message, an average weight of messages, a frequency of messages, a number of messages, a number of words in a message, an identified topic associated with the message, keywords in a message (e.g., work-related words, project-related words, etc.), symbols included in a message (e.g., question marks, exclamation marks, dollar signs, etc.), mentions or names included in a message (e.g., @mention of another user, names of other users, etc.), a number of reactions to a message, types of links or applications associated with a message, files attached or associated with the message, times (e.g., timestamps) associated with messages (e.g., initial message, response time, etc.), and the like. In other words, the characteristics of the messages can be associated with a context and/or content associated therewith.

At operation 1008, the server 102 determines whether a value of a characteristic of the characteristics is equal to or greater than a threshold value. The threshold value may be determined based on the characteristic(s) (e.g., number of words, an identified topic, keywords, weight, frequency, etc.). The value of the characteristic may represent a level of interaction between the first user and the second user. In some examples, the threshold value may be determined based on an expected level of interaction between the first user and the second user, such as based on respective user identifiers, organizational identifiers, group identifiers (e.g., workspace identifiers), team identifiers, organizational data, user data, and the like. For example, the threshold value may be determined based on whether the first user with a first characteristic of a manager and the second user with a characteristic associated with a position that is subordinate to a manager are members of a same organization, same team thereof. In other words, the threshold level can be determined based on whether the first user and the second user, based on their characteristics, would be expected to communicate often and/or substantively in a collaborative manner.

Based on a determination that the value of the characteristic is less than the threshold value (“No” at operation 1008), the server 102, at operation 1010, can optionally determine to maintain an organizational graph associated with the organization. In some examples, the server 102 can determine to not perform any functions with regard to the organizational graph, provide any recommended actions, or the like.

Based on a determination that the value of the characteristic is equal to or greater than the threshold value (“Yes” at operation 1008), the server 102, at operation 1012, sends, to a second client associated with the second user, an invitation for the second user to join the first workspace. In some examples, the server 102 can cause the second client to present the invitation via a user interface associated therewith, such as via user interface 144. In various examples, the invitation can include selectable options to accept and join the first workspace or deny and not join the first workspace.

At operation 1014, the server 102 receives, from the second client, an indication of acceptance of the invitation. In various examples, the indication of acceptance can be received via the selectable option to accept the invitation.

At operation 1016, the server 102 associates the second user with the first workspace based at least in part on the indication of acceptance. In some examples, the server 102 modifies permissions associated with the first workspace to grant the second user access to the first workspace. In such examples, the server 102 can update user data associated with the second user to represent the permissions associated with the first workspace.

At operation 1018, the server 102, updates the organizational graph associated with the organization based on an association of the second user with the first workspace. In some examples, an update to the organizational graph can include an indication that the second user is associated with the first workspace and/or a team associated therewith.

As such, techniques described herein provide specific, technical solutions to technical problems faced by existing systems, the details of which are described above.

### Example Clauses

A: A method, implemented at least in part by one or more computing devices of a communication platform, comprising: receiving, from two or more clients associated with an organization associated with the communication platform, a plurality of messages exchanged between users via the communication platform and associated with an identifier corresponding to the organization; generating, based at least in part on analyzing the plurality of messages associated with the identifier, an interaction graph associated with the organization; determining, based at least in part on comparing the interaction graph and an organizational graph associated with the organization, a threshold level of interaction between two or more users of the users; and based at least in part on the threshold level of interaction, causing a recommended action for a first user to perform with respect to the communication platform to be presented via a first client of the two or more clients, the first client being associated with a first user account of the first user.

B: The method of paragraph A, wherein analyzing the plurality of messages to generate the interaction graph comprises analyzing at least one of: a frequency of messages exchanged between the users; a content associated with each message of the plurality of messages; or a context associated with each message of the plurality of messages.

C: The method of paragraph B, wherein at least one of the content associated with each message or the context associated with each message is determined based at least in part on at least one of: a hyperlink included in a message of the plurality of messages; an attachment included in a message of the plurality of messages an application associated with the message; a characteristic associated with recipients of the message; or a characteristic associated with a sender of the message.

D: The method of any one of paragraphs A-C, wherein determining the threshold level of interaction between the two or more users comprises: identifying a subset of messages of the plurality of messages exchanged between the first user and a second user; determining that a first characteristic associated with the first user is different from a second characteristic associated with the second user; and determining that at least one of a frequency associated with the subset of messages or an average weight associated with the subset of messages is greater than at least one of a threshold frequency or a threshold average weight associated with a level of interaction between the two or more users.

E: The method of any one of paragraphs A-D, wherein determining the threshold level of interaction between the two or more users comprises: identifying a topic associated with a subset of messages of the plurality of messages exchanged between the two or more users; and determining a number of messages associated with the subset of messages is equal to or greater than a threshold number of messages, wherein the recommended action comprises generating a channel between the two or more users based at least in part on the topic.

F: The method of any one of paragraphs A-E, further comprising: determining an average frequency of requests for a particular action received by a group of users associated with a first workspace, wherein each request is transmitted via a respective message of the plurality of messages and comprises a request for a user of the group of users to perform an action; determining that at least one of a current frequency of requests is greater than a threshold frequency or an average response time associated with the plurality of messages is greater than a threshold response time; and based at least in part on the at least one of the current frequency of requests being greater than the threshold frequency or the average response time being greater than the threshold response time, determining that the first workspace is understaffed, wherein the recommended action is based at least in part on the first workspace being overloaded.

G: The method of any one of paragraphs A-F, further comprising: determining, based at least in part on the interaction graph, a level of collaboration between a first group of users associated with a first workspace and a second group of users associated with a second workspace; and determining that the level of collaboration between the first group of users and the second group of users is less than a threshold level of collaboration between the first group of users and the second group of users, wherein determining the threshold level of interaction between the two or more users is based at least in part on the level of collaboration between the first group of users and the second group of users being less than the threshold level of collaboration, and wherein the recommended action comprises an action to increase an amount of communication between the first group of users and the second group of users.

H: The method of any one of paragraphs A-G, wherein the recommended action comprises at least one of: generating a new channel; joining an existing channel; joining a workspace; sending a direct message; creating a direct messaging instance; initiating a video or audio conversation to facilitate collaboration between the two or more users; or generating a board to facilitate collaboration between the two or more users.

I: A system comprising: one or more processors; and one or more computer readable media storing instructions that, when executed, cause the system to perform operations comprising: receiving, from two or more clients associated with an organization associated with a communication platform, plurality of messages exchanged between users via the communication platform and associated with an identifier corresponding to the organization; generating, based at least in part on analyzing the plurality of messages associated with the identifier, an interaction graph associated with the organization; determining, based at least in part on comparing the interaction graph and an organizational graph associated with the organization, a threshold level of interaction between two or more users of the users; and based at least in part on the threshold level of interaction, causing a recommended action for a first user to perform with respect to the communication platform to be presented via a first client of the two or more clients, the first client being associated with a first user account of the first user.

J: The system of paragraph I, wherein analyzing the plurality of messages to generate the interaction graph comprises analyzing at least one of: a frequency of messages exchanged between the users; a content associated with each message of the plurality of messages; or a context associated with each message of the plurality of messages.

K: The system of paragraph J, wherein at least one of the content associated with each message or the context associated with each message is determined based at least in part on at least one of: a hyperlink included in a message of the plurality of messages; an attachment included in a message of the plurality of messages; an application ticket associated with the message; a characteristic associated with one or more recipients of the message; or a characteristic associated with a sender of the message.

L: The system of any one of paragraphs I-K, wherein determining the threshold level of interaction between the two or more users comprises: identifying a subset of messages of the plurality of messages exchanged between the first user and a second user; determining that a first characteristic associated with the first user is different from a second characteristic associated with the second user; and determining that at least one of a frequency or an average weight associated with the subset of messages is greater than at least one of a threshold frequency or a threshold average weight associated with a level of interaction between the two or more users.

M: The system of any one of paragraphs I-L, wherein determining the threshold level of interaction between the two or more users comprises: identifying a topic associated with a subset of messages of the plurality of messages exchanged between the two or more users; and determining a number of messages associated with the subset of messages is equal to or greater than a threshold number of messages, wherein the recommended action comprises generating a channel between the two or more users based at least in part on the topic.

N: The system of any one of paragraphs I-M, the operations further comprising: determining an average frequency of requests for a particular action received by a group of users associated with a first workspace, wherein each request is transmitted via a respective message of the plurality of messages and comprises a request for a user of the group of users to perform an action; and determining that at least one of a current frequency of requests is greater than a threshold frequency or an average response time associated with the plurality of messages is greater than a threshold response time; and based at least in part on the at least one of the current frequency of requests being greater than the threshold frequency or the average response time being greater than the threshold response time, determining that the first workspace is understaffed, wherein the recommended action is based at least in part on the first workspace being overloaded.

O: The system of any one of paragraphs I-N, the operations further comprising: determining, based at least in part on the interaction graph, a level of collaboration between a first group of users associated with a first workspace and a second group of users associated with a second workspace; and determining that the level of collaboration between the first group of users and the second group of users is less than a threshold level of collaboration between the first group of users and the second group of users, wherein determining the threshold level of interaction between the two or more users is based at least in part on the level of collaboration between the first group of users and the second group of users being less than the threshold level of collaboration, and wherein the recommended action comprises an action to increase an amount of communication between the first group of users and the second group of users.

P: One or more non-transitory computer-readable media storing computer-executable instructions that, when executed by one or more processors of a computing device associated with a communication platform, cause the computing device to perform operations comprising: receiving, from two or more clients associated with an organization associated with the communication platform, a plurality of messages exchanged between users via the communication platform and associated with an identifier corresponding to the organization; generating, based at least in part on analyzing the plurality of messages associated with the identifier, an interaction graph associated with the organization; determining, based at least in part on comparing the interaction graph and an organizational graph associated with the organization, a threshold level of interaction between two or more users of the users; and based at least in part on the threshold level of interaction, causing a recommended action for a first user to perform with respect to the communication platform to be presented via a first client of the two or more clients, the first client being associated with a first user account of the first user.

Q: The one or more non-transitory computer-readable media of paragraph P, wherein analyzing the plurality of messages to generate the interaction graph comprises analyzing at least one of: a frequency of messages exchanged between the users; a content associated with each message of the plurality of messages; or a context associated with each message of the plurality of messages.

R: The one or more non-transitory computer-readable media of paragraph Q, wherein at least one of the content associated with each message or the context associated with each message is determined based at least in part on at least one of: a hyperlink included in a message of the plurality of messages; an attachment included in a message of the plurality of messages; an application ticket associated with the message; a characteristic associated with one or more recipients of the message; or a characteristic associated with a sender of the message.

S: The one or more non-transitory computer-readable media of any one of paragraphs P-R, wherein determining the threshold level of interaction between the two or more users comprises: identifying a subset of messages of the plurality of messages exchanged between the first user and a second user; determining that a first characteristic associated with the first user is different from a second characteristic associated with the second user; and determining that at least one of a frequency or an average weight associated with the subset of messages is greater than at least one of a threshold frequency or a threshold average weight associated with a level of interaction between the two or more users.

T: The one or more non-transitory computer-readable media of any one of paragraphs P-S, wherein determining the threshold level of interaction between the two or more users comprises: identifying a topic associated with a subset of messages of the plurality of messages exchanged between the two or more users; and determining a number of messages associated with the subset of messages is equal to or greater than a threshold number of messages, wherein the recommended action comprises generating a channel between the two or more users based at least in part on the topic.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method, implemented at least in part by one or more computing devices of a communication platform, comprising:
receiving, from two or more clients associated with an organization associated with the communication platform, a plurality of messages exchanged between users via the communication platform and associated with an identifier corresponding to the organization;
generating, based at least in part on analyzing the plurality of messages associated with the identifier, an interaction graph associated with the organization;
determining, based at least in part on comparing the interaction graph and an organizational graph associated with the organization, a threshold level of interaction between two or more users of the users; and
based at least in part on the threshold level of interaction, causing a recommended action for a first user to perform with respect to the communication platform to be presented via a first client of the two or more clients, the first client being associated with a first user account of the first user.

2. The method of claim 1, wherein analyzing the plurality of messages to generate the interaction graph comprises analyzing at least one of:
a frequency of messages exchanged between the users;
a content associated with each message of the plurality of messages; or
a context associated with each message of the plurality of messages.

3. The method of claim 2, wherein at least one of the content associated with each message or the context associated with each message is determined based at least in part on at least one of:
a hyperlink included in a message of the plurality of messages;
an attachment included in a message of the plurality of messages;
an application associated with the message;
a characteristic associated with recipients of the message; or
a characteristic associated with a sender of the message.

4. The method of claim 1, wherein determining the threshold level of interaction between the two or more users comprises:
identifying a subset of messages of the plurality of messages exchanged between the first user and a second user;
determining that a first characteristic associated with the first user is different from a second characteristic associated with the second user; and
determining that at least one of a frequency associated with the subset of messages or an average weight associated with the subset of messages is greater than at least one of a threshold frequency or a threshold average weight associated with a level of interaction between the two or more users.

5. The method of claim 1, wherein determining the threshold level of interaction between the two or more users comprises:
identifying a topic associated with a subset of messages of the plurality of messages exchanged between the two or more users; and
determining a number of messages associated with the subset of messages is equal to or greater than a threshold number of messages,
wherein the recommended action comprises generating a channel between the two or more users based at least in part on the topic.

6. The method of claim 1, further comprising:
determining, based at least in part on the interaction graph, a level of collaboration between a first group of users associated with a first workspace and a second group of users associated with a second workspace; and
determining that the level of collaboration between the first group of users and the second group of users is less than a threshold level of collaboration between the first group of users and the second group of users,
wherein determining the threshold level of interaction between the two or more users is based at least in part on the level of collaboration between the first group of users and the second group of users being less than the threshold level of collaboration, and
wherein the recommended action comprises an action to increase an amount of communication between the first group of users and the second group of users.

7. The method of claim 1, wherein the recommended action comprises at least one of:
generating a new channel;
joining an existing channel;
joining a workspace;
sending a direct message;
creating a direct messaging instance;
initiating a video or audio conversation to facilitate collaboration between the two or more users; or
generating a board to facilitate collaboration between the two or more users.

8. A system comprising:
one or more processors; and
one or more computer readable media storing instructions that, when executed, cause the system to perform operations comprising:
receiving, from two or more clients associated with an organization associated with a communication platform, plurality of messages exchanged between users via the communication platform and associated with an identifier corresponding to the organization;
generating, based at least in part on analyzing the plurality of messages associated with the identifier, an interaction graph associated with the organization;
determining, based at least in part on comparing the interaction graph and an organizational graph associated with the organization, a threshold level of interaction between two or more users of the users; and
based at least in part on the threshold level of interaction, causing a recommended action for a first user to perform with respect to the communication platform to be presented via a first client of the two or more clients, the first client being associated with a first user account of the first user.

9. The system of claim 8, wherein analyzing the plurality of messages to generate the interaction graph comprises analyzing at least one of:
a frequency of messages exchanged between the users;
a content associated with each message of the plurality of messages; or
a context associated with each message of the plurality of messages.

10. The system of claim 9, wherein at least one of the content associated with each message or the context associated with each message is determined based at least in part on at least one of:
a hyperlink included in a message of the plurality of messages;
an attachment included in a message of the plurality of messages;
an application ticket associated with the message;
a characteristic associated with one or more recipients of the message; or
a characteristic associated with a sender of the message.

11. The system of claim 8, wherein determining the threshold level of interaction between the two or more users comprises:
identifying a subset of messages of the plurality of messages exchanged between the first user and a second user;
determining that a first characteristic associated with the first user is different from a second characteristic associated with the second user; and
determining that at least one of a frequency or an average weight associated with the subset of messages is greater than at least one of a threshold frequency or a threshold average weight associated with a level of interaction between the two or more users.

12. The system of claim 8, wherein determining the threshold level of interaction between the two or more users comprises:
identifying a topic associated with a subset of messages of the plurality of messages exchanged between the two or more users; and
determining a number of messages associated with the subset of messages is equal to or greater than a threshold number of messages,
wherein the recommended action comprises generating a channel between the two or more users based at least in part on the topic.

13. The system of claim 8, the operations further comprising:
determining, based at least in part on the interaction graph, a level of collaboration between a first group of users associated with a first workspace and a second group of users associated with a second workspace; and
determining that the level of collaboration between the first group of users and the second group of users is less than a threshold level of collaboration between the first group of users and the second group of users,
wherein determining the threshold level of interaction between the two or more users is based at least in part on the level of collaboration between the first group of users and the second group of users being less than the threshold level of collaboration, and
wherein the recommended action comprises an action to increase an amount of communication between the first group of users and the second group of users.

14. The system of claim 8, wherein the recommended action comprises at least one of:
generating a new channel;
joining an existing channel;
joining a workspace;
sending a direct message;
creating a direct messaging instance;
initiating a video or audio conversation to facilitate collaboration between the two or more users; or
generating a board to facilitate collaboration between the two or more users.

15. One or more non-transitory computer-readable media storing computer-executable instructions that, when executed by one or more processors of a computing device associated with a communication platform, cause the computing device to perform operations comprising:
receiving, from two or more clients associated with an organization associated with the communication platform, a plurality of messages exchanged between users via the communication platform and associated with an identifier corresponding to the organization;
generating, based at least in part on analyzing the plurality of messages associated with the identifier, an interaction graph associated with the organization;
determining, based at least in part on comparing the interaction graph and an organizational graph associated with the organization, a threshold level of interaction between two or more users of the users; and
based at least in part on the threshold level of interaction, causing a recommended action for a first user to perform with respect to the communication platform to be presented via a first client of the two or more clients, the first client being associated with a first user account of the first user.

16. The one or more non-transitory computer-readable media of claim 15, wherein analyzing the plurality of messages to generate the interaction graph comprises analyzing at least one of:
a frequency of messages exchanged between the users;
a content associated with each message of the plurality of messages; or
a context associated with each message of the plurality of messages.

17. The one or more non-transitory computer-readable media of claim 16, wherein at least one of the content associated with each message or the context associated with each message is determined based at least in part on at least one of:
a hyperlink included in a message of the plurality of messages;
an attachment included in a message of the plurality of messages;
an application ticket associated with the message;
a characteristic associated with one or more recipients of the message; or
a characteristic associated with a sender of the message.

18. The one or more non-transitory computer-readable media of claim 15, wherein determining the threshold level of interaction between the two or more users comprises:
identifying a subset of messages of the plurality of messages exchanged between the first user and a second user;
determining that a first characteristic associated with the first user is different from a second characteristic associated with the second user; and
determining that at least one of a frequency or an average weight associated with the subset of messages is greater than at least one of a threshold frequency or a threshold average weight associated with a level of interaction between the two or more users.

19. The one or more non-transitory computer-readable media of claim 15, wherein determining the threshold level of interaction between the two or more users comprises:
identifying a topic associated with a subset of messages of the plurality of messages exchanged between the two or more users; and
determining a number of messages associated with the subset of messages is equal to or greater than a threshold number of messages,
wherein the recommended action comprises generating a channel between the two or more users based at least in part on the topic.

20. The one or more non-transitory computer-readable media of claim 15, further comprising:
determining, based at least in part on the interaction graph, a level of collaboration between a first group of users associated with a first workspace and a second group of users associated with a second workspace; and
determining that the level of collaboration between the first group of users and the second group of users is less than a threshold level of collaboration between the first group of users and the second group of users,
wherein determining the threshold level of interaction between the two or more users is based at least in part on the level of collaboration between the first group of users and the second group of users being less than the threshold level of collaboration, and
wherein the recommended action comprises an action to increase an amount of communication between the first group of users and the second group of users.
